(19) United States
(12) Patent Application Publication
(10) Pub. No.: US 2025/0171017 A1
(43) Pub. Date: May 29, 2025

(54) SCENE MODELING USING TRAJECTORY PREDICTIONS AND TOKENIZED FEATURES

(71) Applicant: NVIDIA Corporation, Santa Clara, CA (US)

(72) Inventors: Yuxiao CHEN, Newark, CA (US); Sander TONKENS, San Francisco, CA (US); Marco PAVONE, Stanford, CA (US)

(73) Assignee: NVIDIA Corporation, Santa Clara, CA (US)

(21) Appl. No.: 18/961,764

(22) Filed: Nov. 27, 2024

Related U.S. Application Data
(60) Provisional application No. 63/603,584, filed on Nov. 28, 2023.

(51) Int. Cl. B60W 30/095

(52) U.S. Cl. CPC B60W 30/095

(57) ABSTRACT

In various examples, systems and methods are disclosed relating to generating scene mode conditioned trajectory predictions that are usable for interfacing with an LLM. A system can obtain traffic scene data associated with movement of one or more agents relative to a vehicle navigating through an environment. The system can encode the traffic scene data to determine latent representations of the movement of the one or more agents relative to the vehicle navigating through the environment. Then the system can determine a joint scene mode distribution based at least on the latent representations. The system can then decode the joint scene mode distribution into one or more trajectory predictions and one or more categorical predictions for each agent of the one or more agents.

### CROSS-REFERENCE TO RELATED APPLICATIONS

This application claims the benefit of U.S. Provisional Application No. 63/603,584, filed on Nov. 28, 2023, the contents of which are hereby incorporated by reference in their entirety.

### BACKGROUND

Large language models (LLMs) are increasingly being implemented to handle diverse tasks such as image and video analysis, time-series data analysis, and the like. But the implementation of LLMs in certain domains (e.g., vehicle automation) can be challenging. For example, in the vehicle automation context, perception and planning pipelines generally involve multiple models operating in a coordinated fashion to analyze and control operation of a vehicle navigating through an environment-such as a city or highway with one or more possible lanes of travel. Given the complex nature of these pipelines (and their module interdependencies), it can be difficult to translate the state of the pipeline at any given point in time to a text prompt that is compatible with an LLM, and subsequently incorporate the output of the LLM in that pipeline.

### SUMMARY

Embodiments of the present disclosure relate to systems and methods for implementing a traffic model configured to continuously generate outputs that are usable for, among other things, interfacing with LLMs. More specifically, embodiments disclosed herein relate to systems that can encode traffic scene data (e.g., generated by a perception system) observed over a period of time into an observable latent space. The systems can implement a graph neural network (GNN) in combination with attention-based operations among the nodes of the GNN in between execution of one or more message passing phases) to generate a set of possible trajectories of agents that are represented in this latent space. The possible trajectories can then be sampled to determine a distribution of probable lane modes and scene modes that are used to generate trajectory predictions conditioned based at least on the sampled trajectories (referred to as scene mode-conditioned (SM-conditioned) trajectory predictions). In some embodiments, the systems described herein also utilize a decoder to generate possible trajectories that are associated with the distributions. In some embodiments, these SM-conditioned trajectory predictions can then be represented as a text input and provided to an LLM to provide context representing a scenario in which the vehicle (sometimes referred to as an “ego vehicle”) is operating, the text input being a format that the LLM is configured to obtain as input.

At least one aspect relates to one or more processors. The one or more processors can include one or more circuits. The one or more circuits can obtain traffic scene data associated with movement of one or more agents relative to a machine (e.g., a vehicle, etc.) navigating through an environment. In implementations, the one or more circuits can encode the traffic scene data to determine one or more latent representations of the movement of the one or more agents relative to the machine navigating through the environment. In some implementations, the one or more circuits can determine a joint scene mode distribution based at least on the one or more latent representations. The one or more circuits can decode the joint scene mode distribution into one or more trajectory predictions and one or more categorical predictions for at least one (e.g., each) agent of the one or more agents.

In some implementations, to obtain the traffic scene data, the one or more circuits can obtain the traffic scene data based at least on execution of a perception system. The perception system can be configured to generate the traffic scene data based at least on sensor data generated by one or more sensors of the machine representing positions of the one or more agents relative to the machine. In implementations, to encode the traffic scene data, the one or more circuits can determine one or more latent representations including first pairwise relationships between pairs of agents of the one or more agents and second pairwise relationships between each agent of the one or more agents and a one or more lane segment of a plurality of one or more lane segments of the environment. In implementations, the one or more circuits are to determine a lane mode distribution and a topological (e.g., a homotopy) distribution based at least on the first pairwise relationships and the second pairwise relationships, and determine the joint scene mode distribution based at least on the lane mode distribution and the homotopic distribution.

In implementations, to determine the lane mode distribution and the homotopy distribution, the one or more circuits can execute a graph neural network (GNN) including a plurality of node embeddings and a plurality of edge embeddings based at least on the first pairwise relationships and the second pairwise relationships. The plurality of node embeddings can include a first subset of node embeddings associated with one or more lane segments of the environment, a second subset of node embeddings associated with the movement of one or more agents during a first period of time, and a third subset of node embeddings associated with future movement of the one or more agents during a second period of time. The plurality of edge embeddings can include a first subset of edge embeddings associated with first relationships between the one or more agents and corresponding one or more lane segments of the environment, and a second subset of edge embeddings associated with second relationships between the one or more agents.

In some implementations, to execute the GNN, the one or more circuits, for at least one message passing phase of a plurality of message passing phases, performs an edge update by concatenating at least one edge embedding with two node embeddings corresponding to the edge embedding, and performs a node update by concatenating at least one node embedding with one or more edge embeddings of the plurality of edge embeddings. In implementations, the one or more circuits can, in response to performing the edge update, perform one or more self-attention operations for at least one of the first subset of node embeddings, the second subset of node embeddings, and the third subset of node embeddings. The one or more circuits can perform cross-attention operations between the first subset of nodes and the second subset of nodes, and perform cross-attention operations between the first subset of nodes and the third subset of nodes.

In implementations, to execute the GNN, the one or more circuits can, in response to performing a final edge update and a final node update, determine the joint scene mode distribution based at least on the plurality of node embeddings and the plurality of edge embeddings. The one or more circuits can generate a prompt based at least on the one or more trajectory predictions and the one or more categorical predictions. The prompt can represent the one or more trajectory predictions and the one or more categorical predictions as related to the machine navigating through the environment.

In some implementations, the one or more processors are included in at least one of: a control system for an autonomous or semi-autonomous machine; a perception system for an autonomous or semi-autonomous machine; a system implemented using a robot; an aerial system; a medical system; a boating system; a smart area monitoring system; a system for performing deep learning operations; a system for performing simulation operations; a system for generating or presenting virtual reality (VR) content, augmented reality (AR) content, or mixed reality (MR) content; a system for performing digital twin operations; a system implemented using an edge device; a system incorporating one or more virtual machines (VMs); a system for generating synthetic data; a system implemented at least partially in a data center; a system for performing conversational artificial intelligence (AI) operations; a system for performing generative AI operations; a system implementing language models; a system for performing generative AI operations; a system for implementing vision language models (VLMs); a system for implementing large language models (LLMs); a system for implementing multi-modal language models, a system for hosting one or more real-time streaming applications; a system for performing light transport simulation; a system for performing collaborative content creation for 3D assets; or a system implemented at least partially using cloud computing resources.

An aspect relates to a method. The method can include obtaining traffic scene data associated with movement of one or more agents relative to a machine navigating through an environment, encoding the traffic scene data to determine one or more latent representations of the movement of the one or more agents relative to the machine navigating through the environment, and determining a joint scene mode distribution based at least on the one or more latent representations. In some implementations, the method can include decoding the joint scene mode distribution into one or more trajectory predictions and one or more categorical predictions for at least one (e.g., each) agent of the one or more agents.

In some implementations, obtaining the traffic scene data can include obtaining the traffic scene data based at least on execution of a perception system. The perception system can be configured to generate the traffic scene data based at least on sensor data generated by one or more sensors of the machine representing positions of the one or more agents relative to the machine. In implementations, encoding the traffic scene data can include determining one or more latent representations including first pairwise relationships between pairs of agents of the one or more agents and second pairwise relationships between at least one agent of the one or more agents and a one or more lane segment of a plurality of one or more lane segments of the environment. In some implementations, methods can further include determining a lane mode distribution and a homotopy distribution based at least on the first pairwise relationships and the second pairwise relationships, and determining a joint scene mode distribution based at least on the lane mode distribution and the homotopy distribution.

In implementations, determining the lane mode distribution and the homotopy distribution can include executing a graph neural network (GNN) including a plurality of node embeddings and a plurality of edge embeddings. In some implementations, execution of the GNN can be based at least on the first pairwise relationships and the second pairwise relationships, where the plurality of node embeddings includes a first subset of node embeddings associated with one or more lane segments of the environment, a second subset of node embeddings associated with the movement of one or more agents during a first period of time, and a third subset of node embeddings associated with future movement of the one or more agents during a second period of time. The plurality of edge embeddings can include a first subset of edge embeddings associated with first relationships between the one or more agents and corresponding one or more lane segments of the environment, and a second subset of edge embeddings associated with second relationships between the one or more agents.

In some aspects, executing the GNN can include, for at least one message passing phase of a plurality of message passing phases, performing an edge update by concatenating at least one edge embedding with two node embeddings corresponding to the edge embedding, and performing a node update by concatenating at least one node embedding with one or more edge embeddings of the plurality of edge embeddings. In aspects, in response to performing the edge update, the method includes performing one or more self-attention operations for at least one of the first subset of node embeddings, the second subset of node embeddings, and the third subset of node embeddings, performing cross-attention operations between the first subset of nodes and the second subset of nodes, and performing cross-attention operations between the first subset of nodes and the third subset of nodes. In some aspects, executing the GNN can include, in response to performing a final edge update and a final node update, determining the joint scene mode distribution based at least on the plurality of node embeddings and the plurality of edge embeddings.

Another aspect relates to a system. The system can include one or more processors to perform operations. The operations can include obtaining traffic scene data associated with movement of one or more agents relative to a machine navigating through an environment, and encoding the traffic scene data to determine one or more latent representations of the movement of the one or more agents relative to the machine navigating through the environment. The operations can include determining a joint scene mode distribution based at least on the one or more latent representations. In some implementations, the operations include decoding the joint scene mode distribution into one or more trajectory predictions and one or more categorical predictions for at least one agent of the one or more agents.

In some aspects, the system is included in at least one of: a control system for an autonomous or semi-autonomous machine; a perception system for an autonomous or semi-autonomous machine; a system implemented using a robot; an aerial system; a medical system; a boating system; a smart area monitoring system; a system for performing deep learning operations; a system for performing simulation operations; a system for generating or presenting virtual reality (VR) content, augmented reality (AR) content, or mixed reality (MR) content; a system for performing digital twin operations; a system implemented using an edge device; a system incorporating one or more virtual machines (VMs); a system for generating synthetic data; a system implemented at least partially in a data center; a system for performing conversational artificial intelligence (AI) operations; a system for performing generative AI operations; a system implementing language models; a system for performing generative AI operations; a system for implementing vision language models (VLMs); a system for implementing large language models (LLMs); a system for implementing multi-modal language models; a system for hosting one or more real-time streaming applications; a system for performing light transport simulation; a system for performing collaborative content creation for 3D assets; or a system implemented at least partially using cloud computing resources.

By virtue of the implementation of the techniques described herein, systems and methods involved in determining distributions and one or more possible trajectories of agents operating (e.g., driving, walking, etc.) in proximity to a machine can be configured to generate the distributions described herein and identify possible trajectories while both avoiding mode collapse (a problem involved in training/updating components of models where the components learn to produce only a limited variety of outputs such as, for example, predicted trajectories for agents relative to an ego vehicle) and increase mode diversity (the ability of the model to generate a wide variety of outputs). For example, systems can separately train/update the encoder for encoding the traffic scene data to be used when determining the set of possible trajectories, and train/update the corresponding decoder based at least on non-ground truth latent modes, such training/updating being supervised by consistency losses. This separate training/updating of the encoders and decoders described herein can allow systems to increase the associated mode diversity resulting in the generation of diverse behaviors conditioned on different latent modes with semantic meanings, while further avoiding mode collapse (e.g., consolidation of the possible trajectories to a specific trajectory). As a result, a variety of trajectory predictions can be generated for any given agent relative to an ego vehicle, thereby allowing planners involved in performing operations based at least on these predicted agent trajectories to consider a broader variety of possible trajectories to execute for the ego vehicle. This, in turn, can allow for greater flexibility by the planner to handle more diverse scenarios where the planner would otherwise be constrained to a limited set of operations that can be performed (e.g., when traversing a road, the planner can anticipate multiple scenarios including whether a machine is going to cut—in to an ego machine's path or continue within a current lane of travel along with more accurate probabilities of at least one scenario). Also, by being able to handle more diverse scenarios, ego machines can continue operation through complex scenarios where other planners without the ability to handle such scenarios would otherwise constrain operation by staying in lane, selecting overly-conservative trajectories, or performing minimum risk maneuvers.

Further, by virtue of the implementation of the techniques described herein, systems can be configured to take advantage of LLMs capabilities with logical reasoning and understanding of traffic codes to supplement the SM-conditioned trajectory predictions of the GNN and attention-based operations. For example, systems can generate a text representation of a scene description, candidate modes, and/or a probability of at least one candidate mode, and provide this text representation to an LLM to query the LLM for possible scenario responses (e.g., maneuvers to perform). The LLM can then use logical reasoning and a semantic understanding of applicable traffic codes to recommend one of the provided candidate modes that are then provided as input to a planner to guide the planner when generating trajectories to operate the ego machine. By supplementing the inputs of the data processing pipeline implemented by the ego machine with the outputs generated by the LLMs as described herein, planners can consider the sematic context represented for a given scene in which the ego machine is operating. Planners can also maintain the necessary frame rates for sustained operation of the ego machine by implementing the LLMs in parallel with the planner, thereby minimizing the resource consumption that would otherwise be involved if the LLMs' attention-based mechanisms were implemented directly by the planner (which could require the dedication of significant computing resources to the planner or a reduction in the frame rate that the planner can reliably maintain).

### BRIEF DESCRIPTION OF THE DRAWINGS

The present systems and methods for generating scene mode conditioned trajectory predictions that are usable for interfacing with an LLM are described in detail below with reference to the attached drawing figures, wherein:

FIG. 1 is an example environment in which one or more systems can be implemented to generate scene mode conditioned trajectory predictions that are useable for interfacing with an LLM, in accordance with some embodiments of the present disclosure;

FIG. 2 is a flow diagram of a method for generating scene mode conditioned trajectory predictions that are usable for interfacing with an LLM, in accordance with some embodiments of the present disclosure;

FIG. 3 is an example diagram of a system for generating scene mode conditioned trajectory predictions that are usable for interfacing with an LLM, in accordance with some embodiments of the present disclosure;

FIG. 4 is a diagram of a process for interfacing with an LLM, in accordance with some embodiments of the present disclosure;

FIG. 5 is a diagram of example interactions between node variables and edge variables of the system of FIG. 3, in accordance with some embodiments of the present disclosure;

FIG. 6 is a diagram of scene mode conditioned prediction trajectories generated by a model, in accordance with some embodiments of the present disclosure;

FIG. 7A is a block diagram of an example generative language model system suitable for use in implementing some embodiments of the present disclosure;

FIG. 7B is a block diagram of an example generative language model that includes a transformer encoder-decoder suitable for use in implementing some embodiments of the present disclosure;

FIG. 7C is a block diagram of an example generative language model that includes a decoder-only transformer architecture suitable for use in implementing some embodiments of the present disclosure;

FIG. 8A is an illustration of an example autonomous vehicle, in accordance with some embodiments of the present disclosure;

FIG. 8B is an example of camera locations and fields of view for the example autonomous vehicle of FIG. 8A, in accordance with some embodiments of the present disclosure;

FIG. 8C is a block diagram of an example system architecture for the example autonomous vehicle of FIG. 8A, in accordance with some embodiments of the present disclosure;

FIG. 8D is a system diagram for communication between cloud-based server(s) and the example autonomous vehicle of FIG. 8A, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

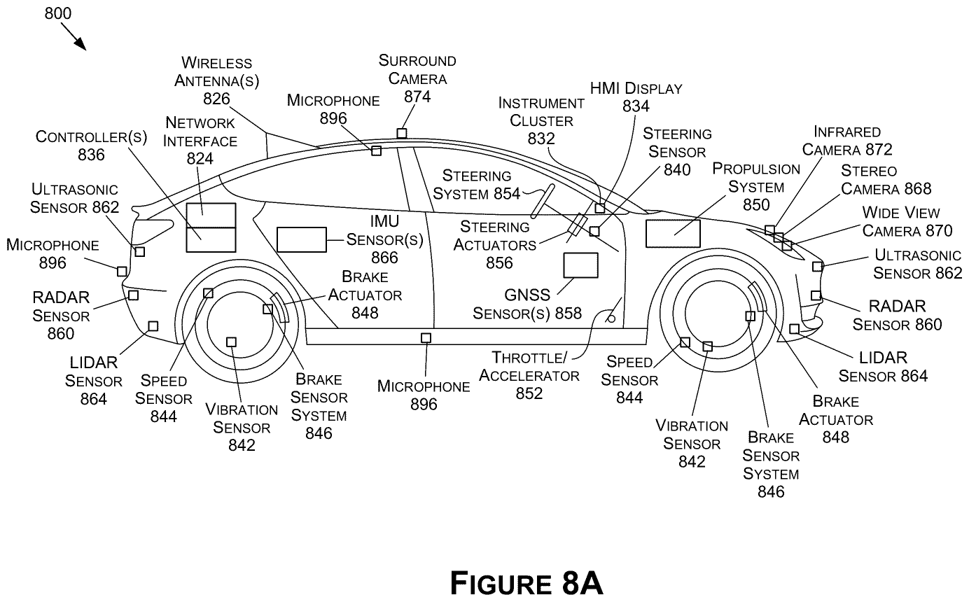

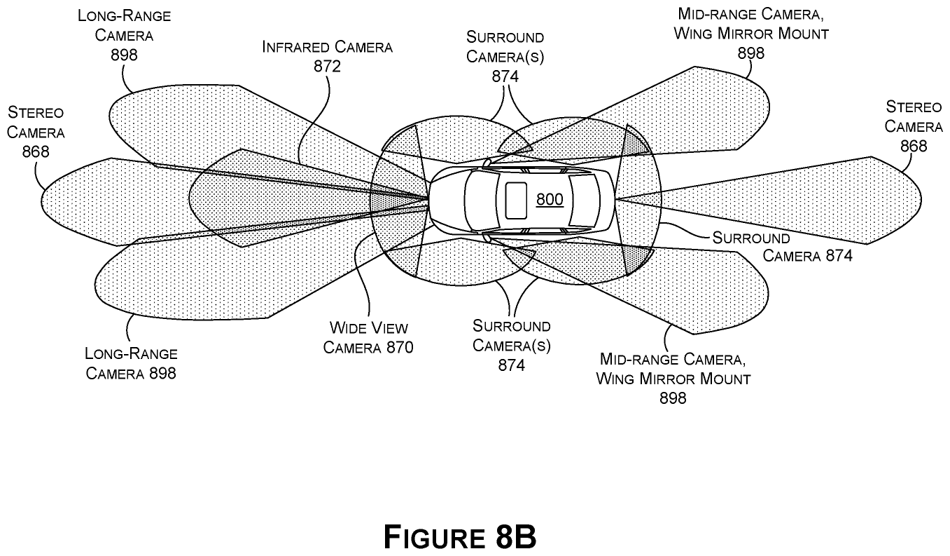

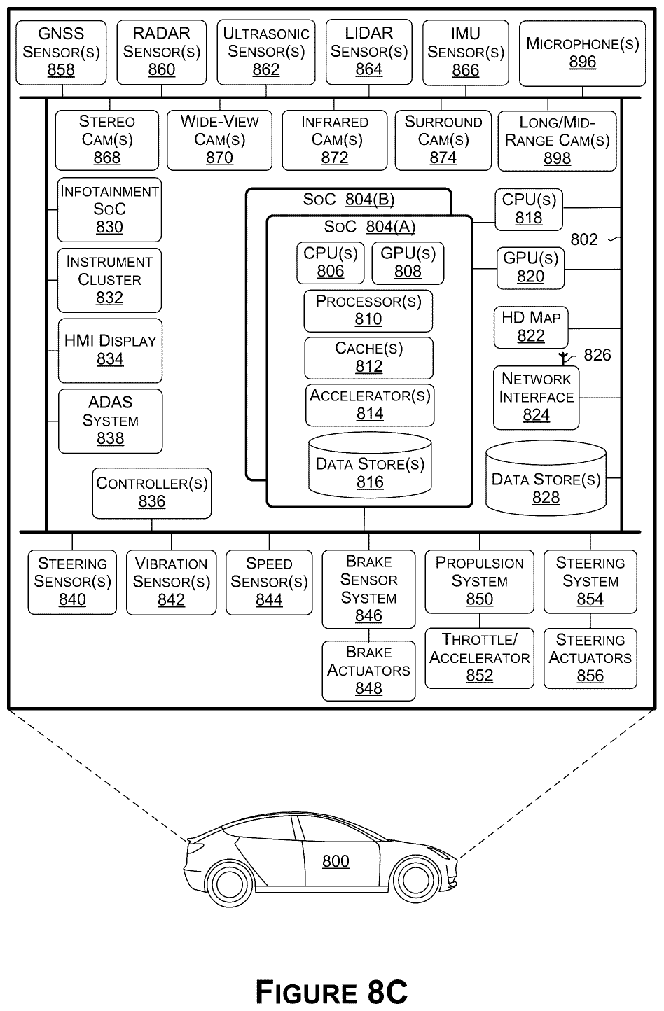

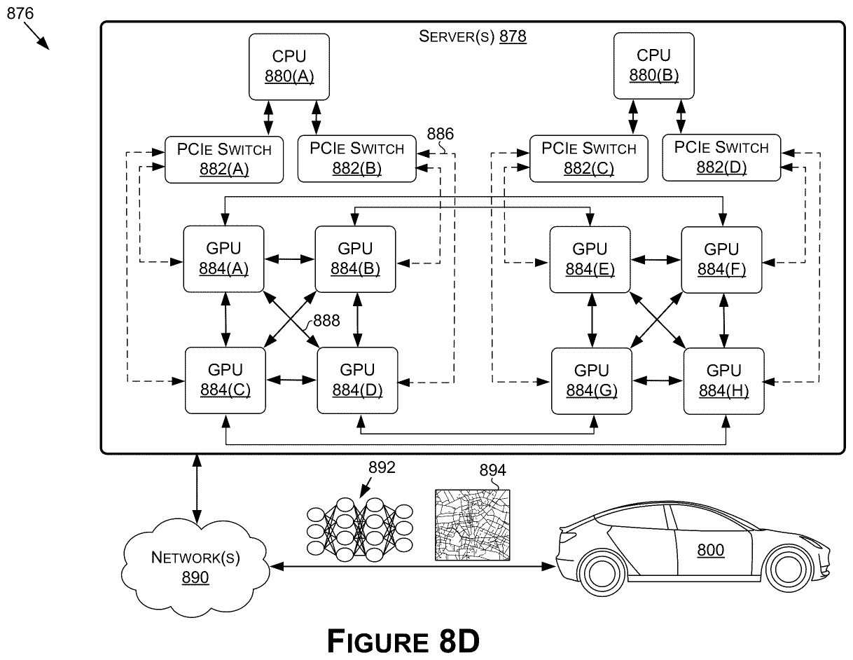

Systems and methods are disclosed that relate to the determination of scene mode conditioned trajectory predictions during automated vehicle operation. Although the present disclosure can be described with respect to an example autonomous vehicle 800 (alternatively referred to herein as “vehicle 800” or “ego-vehicle 800,” an example of which is described with respect to FIGS. 8A-8D), this is not intended to be limiting. For example, the systems and methods described herein can be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure can be described with respect to generating trajectory predictions, this is not intended to be limiting, and the systems and methods described herein can be used in augmented reality, virtual reality, mixed reality, robotics, security and surveillance, autonomous or semi-autonomous machine applications, and/or any other technology spaces where trajectory predictions can be used.

As described herein, a system can obtain scene data (e.g., traffic scene data) including agent histories and locations of one or more lane segments relative to a vehicle navigating through an environment containing one or more agents. The system can then encode the scene data to determine one or more latent representations of the agents and/or lane segments. For example, the system can encode the scene data associated with a traffic scenario by providing the scene data to an encoder that is configured to communicate with a graph neural network (GNN) to generate an output. The output can include data associated with the latent representations of the agents and/or lane segments represented by the scene data. The system can then use the latent representations to determine a lane mode distribution and a homotropy distribution, both of which can then be used to determine a joint scene mode distribution.

In some embodiments, the representations of possible actions of the agents and/or lane segments in a given scene (the SM-conditioned trajectories) can be represented as a text prompt and provided to a large language model (LLM) to cause the LLM to generate an output. In some examples, the probabilities of at least one (e.g., each) SM-conditioned trajectory being realized are also represented by the text prompt. In response to receiving the text prompt, the LLM can generate an output indicating a set of operations to perform (e.g., change lanes, overtake, yield, etc.). The output of the LLM, represented as a text prompt, can then be provided to a planner to cause control of an ego vehicle based at least on the prompt.

When implemented, the disclosed techniques provide improvements over existing methods of generating trajectory predictions during automated vehicle (AV) operation. For example, the presently-disclosed techniques can reduce the latencies inherent when incorporating LLMs into real-time systems (e.g., AVs operating at, e.g., 10/20 Hz (iterations per second)). Further, the disclosed encoder-decoder model can operate in accordance with an interpretable latent space allowing for the separate training/updating of the encoder and decoder. This decoupled training/updating can allow for the avoidance of mode collapse that some methods can suffer from when being trained to generate trajectory predictions during automated vehicle operation. And by decoupling training/updating of the encoder and decoder used to predict trajectories for agents, systems can be configured to encode and interpret the environment by producing multimodal predictions that are a more accurate description of the stochastic distribution of the joint behavior of all agents. This improved and more accurate predicted trajectory can allow downstream planners to generate a trajectory the vehicle should drive along lanes using these multimodal predictions. The trajectory can then be translated into controls signals that are sent to the electronic control systems (actuators, etc.) to operate the automated vehicle.

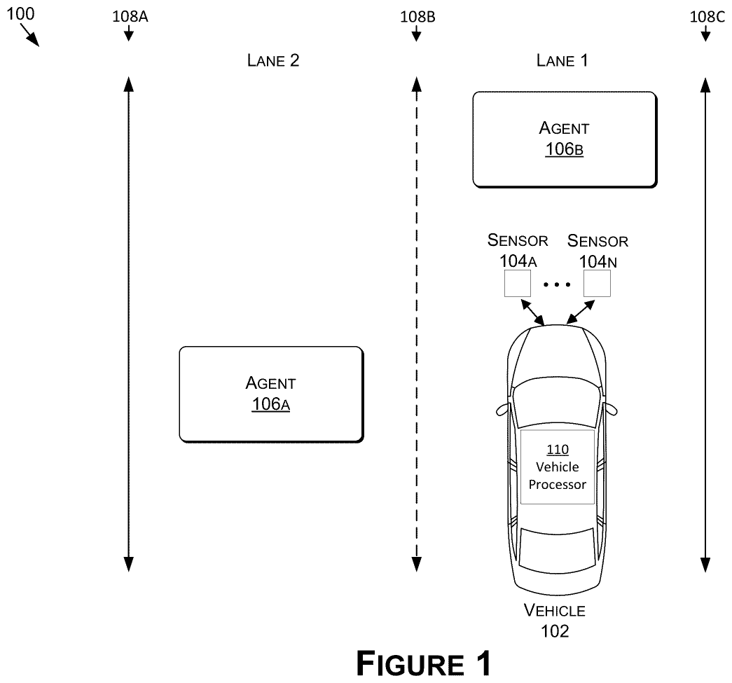

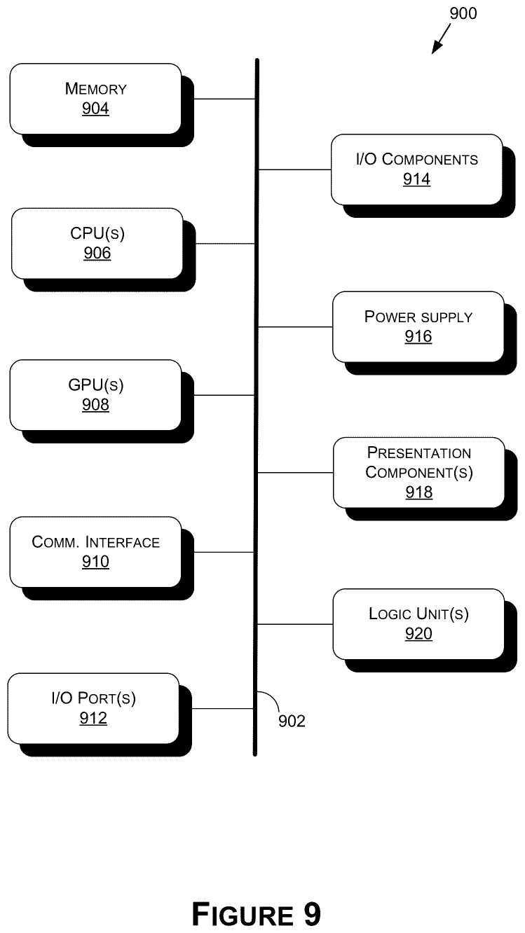

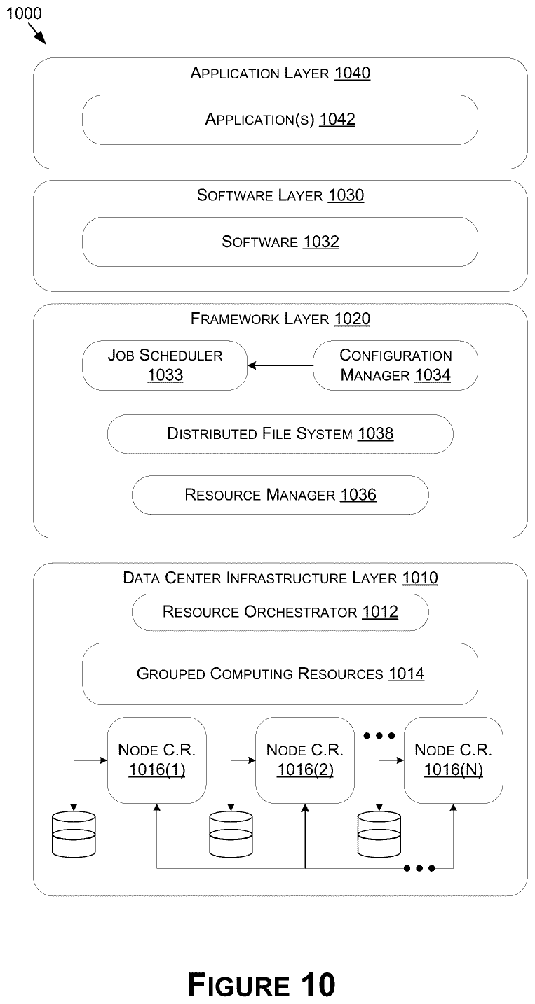

With reference to FIG. 1, FIG. 1 is an example environment in which one or more systems can be implemented to generate scene mode conditioned trajectory predictions that are useable for, among other things, interfacing with an LLM, in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory. In some embodiments, the systems, methods, and processes described herein can be executed using similar components, features, and/or functionality to those of example autonomous vehicle 800 of FIGS. 8A-8D, example computing device 900 of FIG. 9, and/or example data center 1000 of FIG. 10.

The example environment 100 includes a vehicle 102, sensors 104a-104n (referred to collectively as “sensors 104” and individually as “sensor 104”), agents 106A-106B (referred to collectively as “agent 106” and individually as “agent 106” unless otherwise specified), and lane markings 108A-108C (referred to collectively as “lane markings 108” and individually as “lane marking 108”). It will be appreciated that the position and number of agents 106 relative to the vehicle 102, the number of lanes, etc., are provided as an example and that, in other example scenarios, the position and numbers of agents 106 relative to the vehicle 102, number of lanes, etc., can vary.

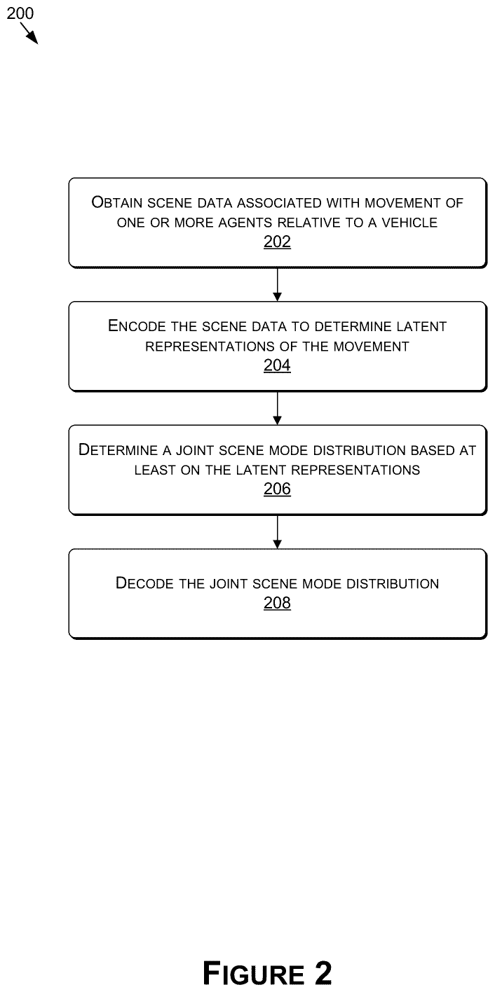

In some embodiments, the vehicle 102 can include any vehicle capable of operating along a drivable surface. In one example, the vehicle 102 can include a car, a truck, a delivery robot, a warehouse robot, etc. that are configured to operate along drivable surfaces. In examples, the vehicle 102 can be operating on a drivable surface such as a street, an interstate, a highway, a pathway, a parking lot, warehouse aisles, etc.). In some embodiments, the vehicle 102 can include one or more components that are the same as, or similar to, the components of the example autonomous vehicle 800 as described herein. For example, the vehicle 102 can include one or more sensors 104 (e.g., LIDAR sensors, RADAR sensors, cameras, etc. that are the same as, or similar to, those described with respect to the example autonomous vehicle 800) that are disposed, supported by, and/or integrated on the vehicle 102. In some embodiments, the vehicle 102 can include one or more computing devices configured to process, store, and/or transmit the data generated by the one or more sensors 104a during operation of the vehicle 102. For example, the vehicle 102 can include a computing device such as one or more SoCs (e.g., SoCs that are the same as, or similar to, the SoCs 804(A), (B) of FIG. 8C) that are interconnected using wired and/or wireless connections to the one or more sensors 104. In examples, the vehicle processor 110 can be configured to perform the methods described in the description of FIG. 2, below. In these examples, the computing devices can be configured to be in direct (e.g., wired) or indirect (e.g., wireless) communication with the one or more sensors of the vehicle 102 and can selectively or continuously process, store, and/or transmit the data generate by the sensors. The computing devices of vehicle 102 can also be configured to determine and provide one or more control signals to be executed by one or more devices of the vehicle 102 to control operation (e.g., navigation, steering, acceleration, braking, etc.) of the vehicles 102 when navigating in the environment.

In some embodiments, the sensors 104a can be any combination of LIDAR sensors, RADAR sensors, etc. that are the same as, or similar to, those described with respect to the example autonomous vehicle 800. For example, a first sensor 104 can include a LiDAR sensor, while a second sensor 104 can include a RADAR sensor. In other embodiments, the sensors 104 can be configured to determine (e.g., measure, derive from the measurements, etc.) characteristics such as (for example and without limitation) one or more of: a position, agent type, sizes, velocity, acceleration, yaw rate, etc. of the agents 106 in the environment 100 in which the vehicle 102 is operating. In some examples, the agents 106 detected by sensors 104 can be located on a drivable surface, such as the drivable surface that vehicle 102 is on, or a non-drivable surface (e.g., a sidewalk, a ditch, an empty lot, etc.). In some embodiments, sensors 104 can detect and determine characteristics of road markings (e.g., lane markings 108, etc.) in the environment.

In some embodiments, the agents 106 can include vehicles that are the same as, or similar to, the vehicle 102. In other embodiments, the agents 106 can be other objects in the environment 100 that the vehicle 102 is navigating through, such as objects on a drivable surface (e.g., traffic cones, pedestrians, trash cans, etc.) or objects on a non-drivable surface (pedestrians, animals, buildings, etc.). The agents 106 can be stationary or moving within the environment 100 and relative to the vehicle 102. In other embodiments, there can be any number of agents 106. For example, in the environment 100 there can be an agent that includes a pedestrian walking along a sidewalk next to a road that the vehicle 102 is driving on, and there can be vehicle agents parked along the side of the road.

In some embodiments, the lane markings 108 can be road markings along the drivable surface that vehicle 102 is operating on. For example, the lane markings 108 can be solid and/or dashed lines marking driving lanes, crosswalks marking where pedestrians can cross the drivable surface, etc. In some embodiments, the lane markings 108 can designate one or more lane segments. Such lane segments can include, for example, portions of a drivable or non-drivable surface that are designated for vehicles, agents, etc., as appropriate.

Now referring to FIG. 2, a flow diagram of a method 200 for generating scene mode conditioned trajectory predictions that are usable for, among other things, interfacing with an LLM is shown, in accordance with some embodiments of the present disclosure. Each block of method 200, described herein, comprises a computing process that can be performed using any combination of hardware, firmware, and/or software. For instance, various functions can be carried out by a processor executing instructions stored in memory. The method 200 can also be embodied as computer-usable instructions stored on computer storage media. The methods can be provided by a standalone application, a service or hosted service (standalone or in combination with another hosted service), or a plug-in to another product, to name a few. In addition, the method 200 is described, by way of example, with respect to the environment 100 of FIG. 1. However, the method 200 can additionally or alternatively be executed by any one system, or any combination of systems, including, but not limited to, those described herein.

In some embodiments, the computing process can be carried out by one or more processors contained in a planning system and/or a control system for an autonomous or semi-autonomous machine (e.g., a vehicle that is the same as, or similar to, the vehicle 102 of FIG. 1, vehicle 800 of FIG. 8A-8D, etc.). In some embodiments, the one or more processors can be contained in a perception system for an autonomous or semi-autonomous machine (e.g., sensors 104 of FIG. 1, etc.). In embodiments, the one or more processors can be contained in a system implemented using a robot, an arial system, a medical system, a boating system, a smart area monitoring system, a system for performing deep learning operations, a system for performing simulation operations, and/or a system for generating or presenting virtual reality (VR) content, augmented reality (AR) content, or mixed reality (MR) content. In some embodiments, the one or more processors can be contained in a system for performing digital twin operations, a system implemented using an edge device, a system incorporating one or more virtual machines (VMs), a system for generating synthetic data, a system implemented at least partially in a data center, and/or a system for performing conversational artificial intelligence (AI) operations. In other embodiments, the one or more processors can be contained by a system for performing generative AI operations, a system implementing language models, a system for implementing vision language models (VLMs), a system for implementing large language models (LLMs), a system for hosting one or more real-time streaming applications, a system for performing light transport simulation, a system for performing collaborative content creation for 3D assets, and/or a system implemented at least partially using cloud computing resources.

The method 200, at block 202, includes obtaining scene data. For example, a vehicle processor (e.g., a vehicle processor that is the same as, or similar to, the vehicle processor 110 of FIG. 1) can obtain (e.g., receive, request, etc.) the scene data associated with movement of one or more agents (e.g., agents 106, etc.) relative to a vehicle (e.g., vehicle 102 of FIG. 1, vehicle 800 of FIG. 8A-D, etc.) navigating through an environment. In some embodiments, the vehicle processor can obtain the scene data from a perception system (e.g., a perception system that is implemented by the vehicle processor). For example, the vehicle processor can implement a perception system that is configured to obtain the sensor data generated by one or more sensors (e.g., that are the same as, or similar to, the sensors 104 of FIG. 1) and generate the scene data. In this example, the sensor data can represent the positions of the one or more agents relative to the vehicle as each moves relative to one another and/or the environment in which the vehicle is operating.

In some embodiments, the scene data can indicate one or more characteristics (e.g., the type, size, velocity, acceleration, yaw rate, etc.) of the one or more agents. Additionally, or alternatively, the scene data can indicate the position of at least one of the one or more agents relative to the vehicle and/or the lane segments. In some embodiments, the scene data can indicate one or more lane markings. For example, the scene data can indicate one or more lane markings in the environment (e.g., demarking the lanes in proximity to the vehicle) that can be used by the vehicle processor to determine one or more lane segments. In this example, the one or more lane markings can define the edges of the one or more lane segments or one or more boundaries between lanes and non-drivable surfaces. As will be understood, the scene data can be based at least on sensor data associated with one or more sensors of the vehicle and/or a correlation (e.g., a match) between portions of the sensor data and one or more predetermined maps (e.g., high-resolution maps captured at earlier points in time of the environment).

In some embodiments, the scene data can be associated with agent histories and/or agent-lane relationships involving the one or more agents and/or lane segments in the environment in which the vehicle is operating. For example, the scene data can be associated with agent histories that indicate positions of the agents relative to the vehicle and/or the environment over time as measured by the sensors of the vehicle. In another example, the scene data can be associated with agent-lane relationships that indicate the lane segments where agents are located, whether the agents are moving in a direction of travel established for the lane segments, a rate of speed at which the agents are moving, etc., as measured by the sensors of the vehicle. In some embodiments, the vehicle processor can determine the agent histories and/or the agent-lane relationships for each frame processed by a perception system implemented by the vehicle processor. For example, the vehicle processor can implement a perception system to analyze the sensor data generated by the sensors of the vehicle to determine the agent histories and/or the agent-lane relationships. In this example, the perception system can be configured to obtain and analyze the sensor data generated by the sensors of the vehicle and interpret the environment, including as the location and movement of the agents within the environment relative to one or more lanes.

In some embodiments, the vehicle processor can generate an agent history to document (e.g., index) the relative position of the one or more agents compared to the vehicle as they move through the environment. For example, the vehicle processor can generate an agent history of the position and motion of the one or more agents relative to the environment at one or more points in time prior to an instant point in time, such position and motion commonly referred to as tracks. In one example, as an agent (e.g., a pedestrian) walks in parallel with the vehicle, the agent history can document the position of the pedestrian relative to the environment in which the vehicle and pedestrian are located, thereby establishing a track formed by the pedestrian as they move through the environment. The scene data associated with the agent-lane relationships can also document the relative position of the one or more agents compared to the one or more lane segments. In an example, as an agent (e.g., a second vehicle) moves within a lane running parallel with the vehicle, the agent history can document the movement of the second vehicle along the lane (e.g., indicating rates of speed, lateral distance to one or more lane markings, etc.).

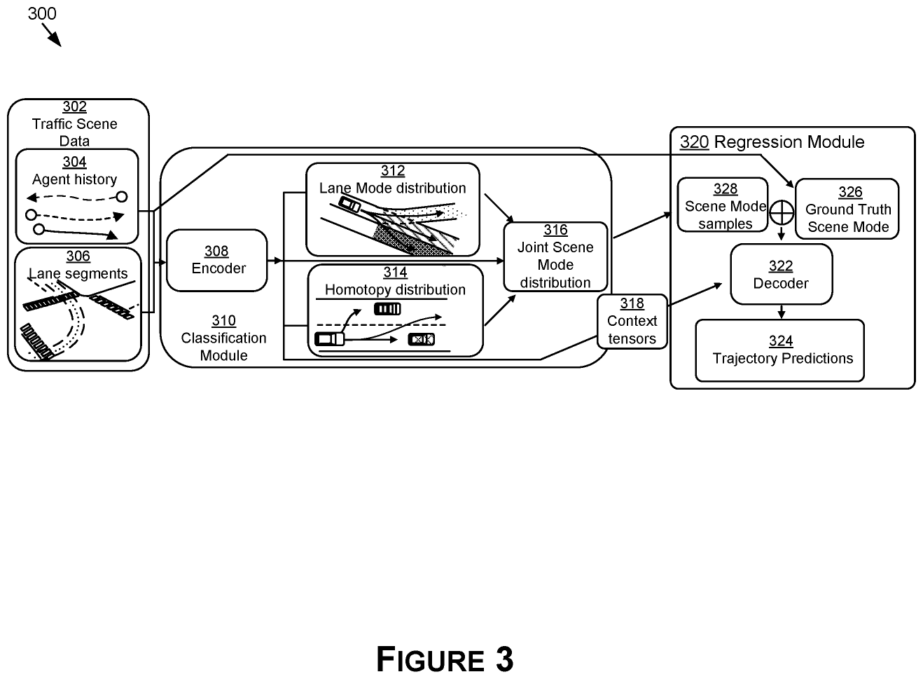

The method 200, at block 204 includes encoding the scene data. For example, the vehicle processor can encode the scene data using an encoder (e.g., an encoder that is the same as, or similar to, the encoder 308 of FIG. 3) to determine latent representations of the movement of the one or more agents relative to the vehicle navigating through the environment. In examples, the vehicle processor can determine the latent representations between each agent of the one or more agents and one or more other agents and/or one or more lane segments of the environment based at least on the scene data. In some embodiments, the latent representations can include first pairwise relationships and second pairwise relationships. The first pairwise relationships can describe the relationships between pairs of the one or more agents in the environment. For example, the first pairwise relationships can represent the relative position and/or motion between the pairs of agents where such motion is static (e.g., the agents are fixed in relation to one another), moving in a clockwise direction or moving in a counterclockwise direction in comparison to each other (e.g., turning), extending or reducing in lateral or longitudinal distance relative to one another (e.g., where one agent is accelerating at a faster or slower rate than the other), etc. Additionally, or alternatively, the first pairwise relationship can represent the angular distance between one or more agents the position of the agents changes over time, as described herein.

In some embodiments, the second pairwise relationship can represent the relative position of one or more agents relative to one or more lane segments of the environment. For example, the vehicle processor can determine second pairwise relationships for one or more of the agents and lane segments in the environment in which the vehicle is operating and assign a label to the pairs of agents and lane segments. The labels can indicate if each of the one or more agents is on, is not on, ahead of, behind of, to the left of, to the right of, misaligned with, etc., any of the lane segments. In another example, the vehicle processor can determine a second pairwise relationship and assign a label (e.g., a null label) where an agent is not associated with any lane segments (e.g., is parked on a non-drivable surface such as beyond a shoulder of a highway). In some embodiments, the vehicle processor can use the second pairwise relationship to generate a token representing the agent-lane history of a given agent and/or lane segment and provide the token to the encoder that is configured to encode the scene data. For example, the vehicle processor can cause the encoder to generate an output indicating the second pairwise relationship at the end of the prediction horizon as described herein to represent part of a scene mode.

In embodiments, the vehicle processor can determine a lane mode distribution (e.g., that is the same as, or similar to, the lane mode distribution 312 of FIG. 3) and a homotopy scene mode distribution (e.g., a homotopy distribution that is the same as, or similar to, the homotopy distribution 314 of FIG. 3). For example, the vehicle processor can determine a lane mode distribution and a homotopy scene mode distribution based at least on the first pairwise relationships and the second pairwise relationships. In this example, the lane mode distribution can represent a probability (e.g., a marginal log probability) that is based at least on the second pairwise relationships and indicates that a given agent will traverse one or more lane segments at one or more future points in time in accordance with the probability, and the homotopy distribution can represent a probability that is based at least on the first pairwise relationships and indicates that the vehicle can generate trajectories in accordance with one or more homotopies determinable by a planning system and the corresponding probability.

In some embodiments, to determine the lane mode distribution and the homotopy distribution, a graph neural network (GNN) can be executed. The GNN can include a neural network designed to process and analyze graphical representations of data. For example, the GNN can be configured to obtain graphs as an input, where one or more nodes of the graph are associated with node embeddings as described herein and are connected by one or more edges as described herein. In some embodiments, the GNN can learn the embeddings for one or more nodes that capture features and relationships between nodes, pass information between nodes through one or more rounds of message passing, and update each node by aggregating information from surrounding nodes.

In some embodiments, the vehicle processor can implement the GNN to include a plurality of node embeddings and a plurality of edge embeddings. In some examples, the plurality of node embeddings and the plurality of edge embeddings can be based at least on the first pairwise relationships and the second pairwise relationships. In some embodiments, the plurality of node embeddings can include a first subset of node embeddings that are associated with lane segments of the environment, a second subset of node embeddings that are associated with the movement of one or more agents during a first period of time (e.g., historical movement of the one or more agents at points in time prior to a current point in time), and a third subset of node embeddings associated with future movement of the one or more agents during a second period of time (e.g., future (e.g., anticipated) movement of the one or more agents at points in time after the current point in time). The plurality of node embeddings can be generated based at least on local information (e.g., the relative position and motion of agents relative to one another and the environment as measured by the one or more sensors of the vehicle) with or without reference (e.g., registration) with global coordinates. In addition, the plurality of node embeddings can be obtained by concatenating information indicating one or more characteristics, such as (for example and without limitation): agent types (e.g., that a given agent is a vehicle, a bicyclist, a pedestrian, etc.), sizes (e.g., numbers of voxels associated with the agents), velocities of the agents, rates of acceleration of the agents, yaw rates of the agents, and embedding the raw features determined by the perception system implemented by the vehicle processor. In some embodiments, the GNN can directly share the plurality of node embeddings with the encoder and/or decoder described herein.

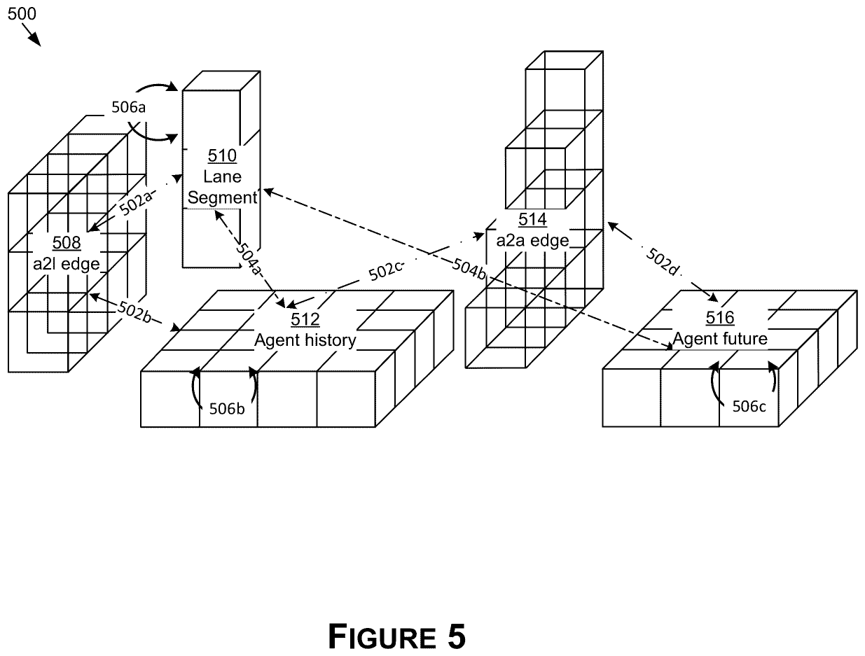

In some embodiments, the plurality of edge embeddings can represent the relationships and/or correlations between one or more of the plurality of node embeddings. For example, the plurality of edge embeddings can be based at least on the first pairwise relationships and the second pairwise relationships. The plurality of edge embeddings can include a first subset of edge embeddings and a second subset of edge embeddings. For example, the first subset of edge embeddings can represent first relationships (e.g., correlations) between the agents and lane segments as described herein that are based at least on the first pairwise relationships and the second pairwise relationships. In this example, at least one embedding of the first subset of edge embeddings can correspond to a first point or period of time (e.g., movement of the one or more agents at points in time prior to a current point in time) such that the first relationships are representative of historical motion of the vehicle and/or agents. In examples, the lane segments can be represented as polylines consisting of multiple waypoints that are based at least on lane markings in the environment. The plurality of edge embeddings can further include a second subset of edge embeddings that represent second relationships that are based at least on the first pairwise relationships and the second pairwise relationships. In examples, an (at least one) embedding of the second subset of edge embeddings can correspond to a second point or period of time or the second point or period of time such that one or more of the second relationships is indicative of possible motion of the vehicle and/or each agent. A detailed description of a GNN is described herein with respect to the diagram of example interactions between node variables and edge variables of FIG. 5.

In some embodiments the first subset of node embeddings, the second subset of node embeddings, and the third subset of node embeddings can include a modifiable level of granularity which can adjust the sampling complexity implemented by the vehicle processor. For example, a low level of granularity of the first subset of node embeddings can detail a single lane segment representing the entirety of the drivable surface occupied by the vehicle and the agents. While a high level of granularity can break the drivable surface up into two or more lane segments in the environment. In embodiments, the first subset of node embeddings can include one or more sub-groups, a pairwise sub-group and/or a unitary sub-group. The pairwise sub-group can indicate one or more statuses between the one or more of the agents and the one or more lane segments. The statuses can indicate if one of the one or more agents is or is not on a lane segment, to the left of a lane segment, to the right of a lane segment, or misaligned with a lane segment.

In some embodiments, the vehicle processor can implement a plurality of message passing phases when executing the GNN. The plurality of message passing phases can be accomplished based at least on the vehicle processor implementing a message passing application programming interface (API) that passes messages for any combination of embeddings. For example, for each message passing phase of the plurality of message passing phases, the vehicle processor can perform an edge update by concatenating each edge embedding with two node embeddings that correspond to the edge embedding. In some embodiments, the edge update can pass through a multi-layer perceptron (MLP) and a residual connection after concatenating the edge embeddings. In another example, the vehicle processor can perform a node update by concatenating each node embedding with one or more edge embeddings of the plurality of edge embeddings. In some embodiments, the node update can pass through an MLP, a pooling layer, and a residual connection after concatenating each node.

In embodiments, custom edge functions can be used during the edge update, which can include two custom edge functions. The two custom edge functions can include a first edge function associated with the first subset of edge embeddings and a second edge function associated with the second subset of edge embeddings. The vehicle processor can implement the first edge function to calculate the relative position between one or more agents in the environment in a local coordinate frame. Similarly, the vehicle processor can implement the second edge function to output a projection of the agent's position on the lane polyline as well as the starting and ending points of the lane segment in a coordinate frame established for the agent.

In embodiments, the vehicle processor can perform a series of operations in response to performing the edge update. For example, the vehicle processor can perform self-attention operations for each of the first subset of node embeddings, the second subset of node embeddings, and the third subset of node embeddings. In some examples, self-attention operations can include calculating attention scores for elements within each subset of node embeddings. In examples, the vehicle processor can perform cross-attention operations between the first subset of nodes and the second subset of nodes. In another example, the vehicle processor can perform cross-attention operations between the first subset of nodes and the third subset of nodes. In some embodiments, cross-attention can include determining a query for one subset of nodes that attends to the elements of another subset of nodes.

The method 200, at block 206 can include determining a joint scene mode distribution. For example, the vehicle processor can determine a joint scene mode distribution based at least on the latent representations encoded by the vehicle processor. In some embodiments, the vehicle processor can determine the joint scene mode distribution in response to the vehicle processor determining an unnormalized log-likelihood for a set of latent representations. For example, the vehicle processor can implement an energy-based function can determine a sampled joint scene distribution for a subset of latent representations selected by the decoder. In some embodiments, the function can be trained/updated to generate the sampled joint scene distribution given the subset of latent representations as described herein.

Training/updating the energy-based function can involve selecting a training/updating subset of latent representations when sampling from among a plurality of possible latent representations. For example, the encoder and/or decoder described herein can decompose each latent representations of the training/updating subset of latent representations into the first pairwise relationships and the second pairwise relationships. The encoder and/or decoder can then score each factor (agent-to-lane factors, agent-to-agent factors, etc.) based at least on the distance of the agent to the vehicle, the distance of the lane segment to the vehicle, and the concentration of the lane mode distribution and/or the homotopy distribution. In addition, all unselected factors can be fixed to their most likely mode from the tensor product of the lane mode distribution and/or the homotopy distribution. A score can then be calculated for each fixed unselected factor. The training/updating subset of latent representation can then be determined based at least on the score of each factor. The variables of the function can be varied to optimize a cross entropy loss enabling the function to accurately generate the sampled joint scene distribution based at least on encoder selected latent representations. Additional details regarding the training/updating of the energy-based function are included the description of FIG. 3.

In some embodiments, in response to the GNN performing a final edge update and a final node update, the joint scene mode distribution can be determined based at least on the plurality of node embeddings and the plurality of edge embeddings. For example, after the GNN performs the final edge update, the final node updated, and edges are pooled on the time axis, the agent axis, and the lane axis, and one or more scalars can be obtained for a (e.g., at least one, each, etc.) latent representation. The one or more scalars can then be output by the GNN as representing the joint scene mode distribution.

The method 200, at block 208 includes decoding the joint scene mode distribution. For example, the vehicle processor can decode the joint scene mode distribution into one or more trajectory predictions and/or one or more categorical predictions for the one or more agents. In some embodiments, the one or more trajectory predictions and/or one or more categorical predictions can be selected by the decoder from the latent representations, the joint distribution, and/or the sampled joint distribution. In other embodiments the one or more trajectory predictions and/or one or more categorical predications can be generated by an autoregressive process involving masking out unknown future blocks or decoding the whole trajectory in one-shot.

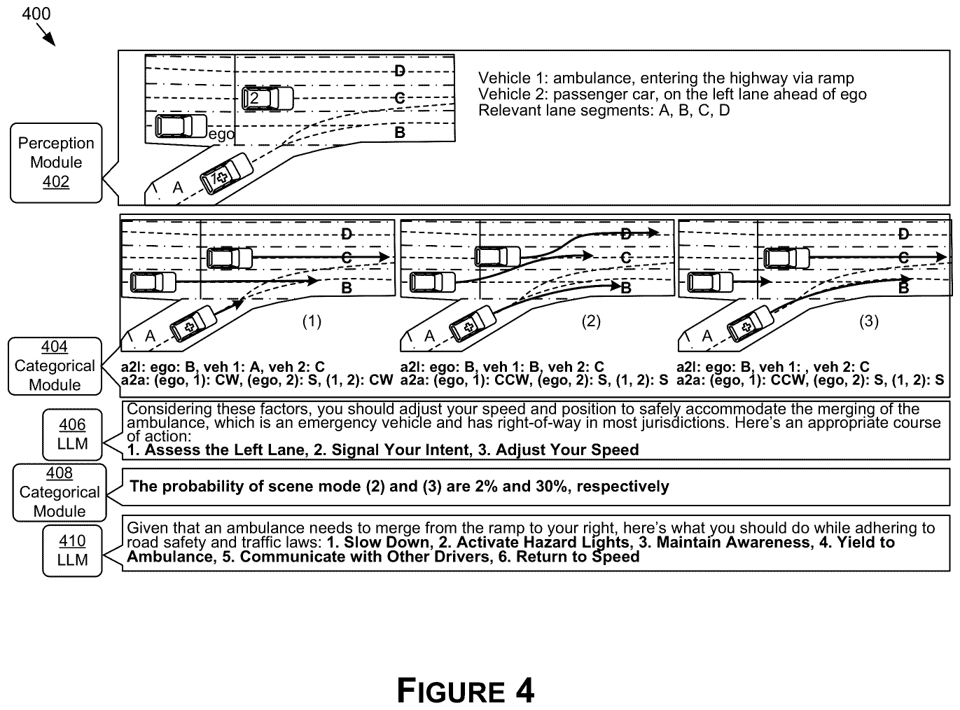

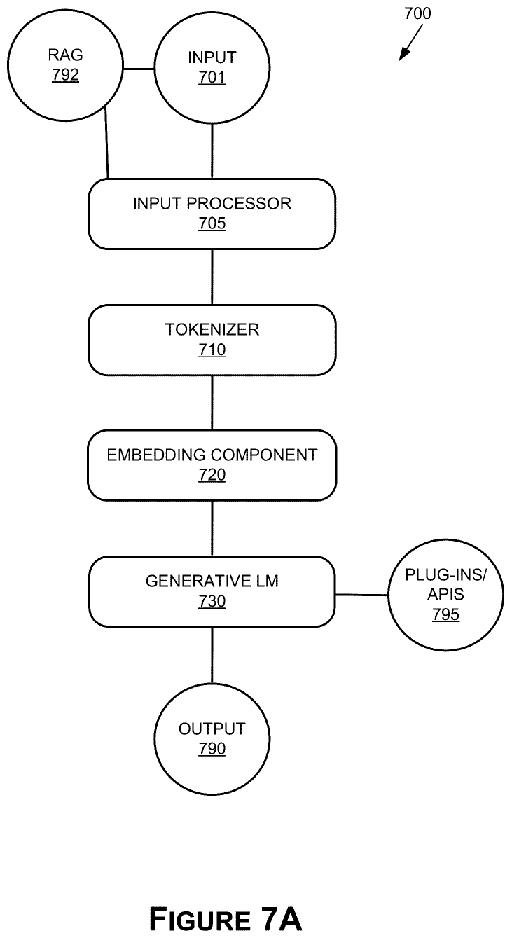

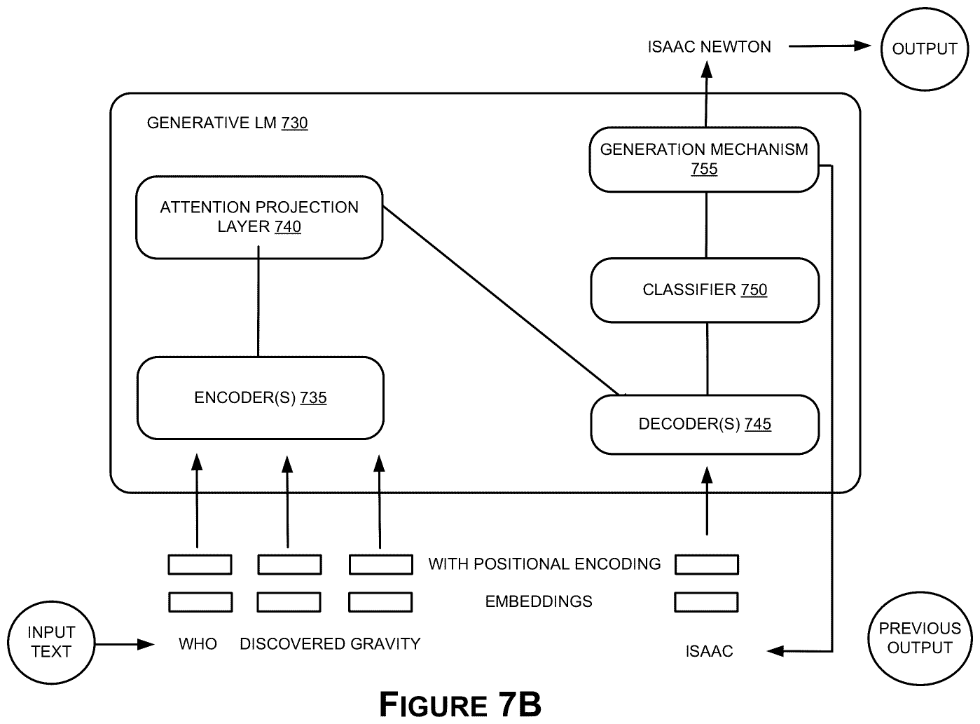

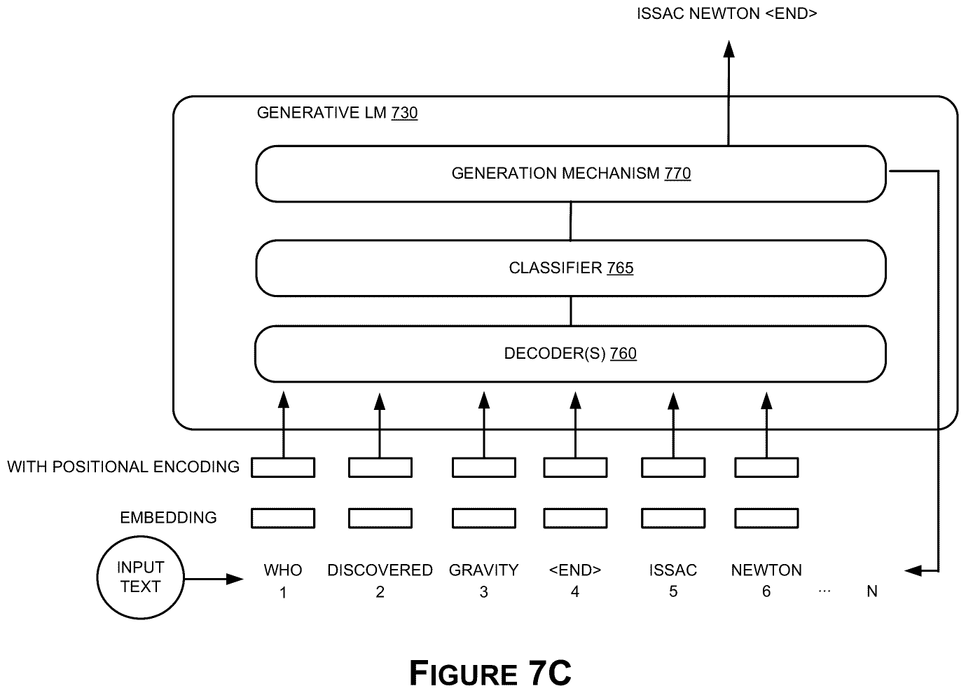

In some embodiments, the vehicle processor can generate one or more text prompts based at least on the one or more trajectory predictions. For example, the vehicle processor can generate a text prompt based at least on the one or more trajectory predictions and the one or more categorical predictions. The text prompt can represent the one or more trajectory prediction and the one or more categorical predications as related to the vehicle navigating through the environment. For example, the prompt can include “the vehicle is traveling in the right-most lane on a highway, an agent is attempting to merge into the same lane from an on-ramp.” The prompt can then be inputted to an LLM (e.g., an LLM that is the same as, or similar to, the LLM of FIG. 4 and/or the language model system 700 of FIG. 7A) to cause the LLM to generate an output. The output can indicate one or more actions to be taken by the vehicle in a given scenario. In some embodiments, the vehicle processor can generate additional information to be provided as subsequent input to the LLM such as text representations of possible trajectories for the vehicle to take in the current environment as well as probabilities that a given scene mode will be realized. The vehicle processor can then provide the additional information as subsequent text prompt(s) to the LLM to cause the LLM to generate an additional output that indicates an action to take that is based at least on the probabilities of each scene mode involved in a given scenario. In some embodiments, the vehicle processor can then generate control data to provide to a planning system and/or a control system to update one or more trajectories to be selected and/or control signals to be transmitted to cause operation of the vehicle in accordance with the output(s) of the LLM.

Referring now to FIG. 3, an example diagram of a system 300 for generating scene mode conditioned trajectory predictions that are usable for interfacing with an LLM is shown, in accordance with some embodiments of the present disclosure. The system 300 can include an encoder 308 and/or decoder 322 that form at least a portion of a classification module 310 and a regression module 320, respectively.

In some embodiments, the classification module 310 can obtain scene data 302 which can include an agent history 304 and lane segments 306. The classification module 310 can include an encoder 308 that is configured to generate a lane mode distribution 312 and/or a homotopy distribution 314, both of which can be used to generate a joint scene mode distribution 316. A regression module 320 can obtain the joint scene mode distribution 316 and/or context tensors 318 from classification module 310. In examples, the regression module 320 can include scene mode samples 328 and a ground truth scene mode 326 which can be used by decoder 322 to generate trajectory predictions 324.

In some embodiments, the encoder 308 can utilize an interpretable set of modes (e.g., scene modes) that are directly identifiable from a ground truth future rollout as the latent variable. Scene modes can be categorical and can include two parts, one or more agent-to-lane (a2l) modes and one or more agent-to-agent (a2a) modes. In embodiments, the a2l modes can describe the relationships between one or more agents (e.g., agents that are the same as, or similar to, agents 106 of FIG. 1, etc.) in the environment of the vehicle (e.g., vehicles that are the same as, or similar to, vehicle 102 of FIG. 1, etc.). The a2a modes can describe the relationships between the one or more agents and one or more lane segments, denoted by one or more lane markings (e.g., lane markings that are the same as, or similar to, the lane markings 108 of FIG. 1, etc.), in the environment of the vehicle. In another embodiment, the a2l modes can be denoted by L and the a2a modes can be denoted by H. The goal of encoder 308 can be to correctly predict ground truth scene mode 326 from the environment's static features and agent history 304. The goal of decoder 322 can be to reconstruct the agents' future trajectories under any given scene mode. In some embodiments, the a2l and a2a modes can be utilized to provide a skeleton of how the agents in the environment can proceed, also known as the scene rollout. The a2l and a2a modes can also represent the multimodal behaviors observed in the environment (e.g., by sensors of the vehicle that are the same as, or similar to, the sensors 104 of FIG. 1). In other embodiments, the level of mode granularity of the scene modes can be modifiable to control the level of expression and sampling complexity.

In other embodiments, there can be two types of a2l modes: a pairwise a2l mode and a unitary a2l mode. For example, given N agents, M nearby lane segments, at any given time step, a pairwise a2l mode can label each agent-lane pair with one of the following labels: l(x(t), 1)∈ [symbol] [symbol] :=[NOT ON, ON, AHEAD, BEHIND, LEFTOF, RIGHTOF, MISALIGN], where x is the state trajectory and I is the lane object. A scene pairwise a2l model can then be calculated based at least on the product of the a2l mode of every agent-lane pair or, in embodiments, can be calculated using: L∈ [symbol] [symbol] ^{N·M}. The unitary a2l mode can label which lane segment each agent in the environment is on at a given time step. In some embodiments, a null label can be assigned to one or more agents that are not on any of the lane segments. The unitary a2l model can be represented using L∈[0, . . . , M]^{N} where the set [0, . . . , M] indicates M lane segments and a zero indicates a null label.

In some embodiments, the a2l mode (e.g., pairwise a2l mode and/or unitary 121 mode) can be used to tokenize the history agent-lane relationship and/or used by encoder 308 to predict the a2l mode at the end of a prediction horizon. For example, the a2l mode the a2l scene mode can be used to calculate the history agent-lane relationship for each history frame of the scene data, which can then be provided as an input to the encoder 308. In another example, encoder 308 can use the predicted a2l mode as part of the scene mode.

In embodiments, the a2a mode can describe the interactions between the agents in the environment. For example, a free-end homotopy can be utilized to categorize the relative motion between pairs of the agents into at least one of three modes: static, clockwise, and/or counterclockwise. These modes can be described using the following equation:

$$h := \{ \begin{matrix}CW , & Δ θ ( {x}_{1} , {x}_{2} ) < - \hat{θ} \\ S , & - \hat{θ} \leq Δ θ ( {x}_{1} , {x}_{2} ) < \hat{θ} \\ CCW , & Δ θ ( {x}_{1} , {x}_{2} ) > \hat{θ}\end{matrix}$$

The modes, represented above by h, can be represented over a time period and can be computed per history frame of the history agent to agent relationship. Where x₁ and x₂ represent the trajectories of a first agent and a second agent of the pair of agents under a fixed time window, \hat{θ} is a fixed threshold, and Δθ is the angular distance between the first agent and the second agent. Δθ can be calculated using:

$$Δ θ ( {x}_{1} , {x}_{2} ) := {\sum }_{i = 1}^{T - 1} arctan \frac{{Y}_{1}^{i + 1} - {Y}_{2}^{i + 1}}{{X}_{1}^{i + 1} - {X}_{2}^{i + 1}} - arctan \frac{{Y}_{1}^{i} - {Y}_{1}^{i}}{{X}_{1}^{i} - {X}_{1}^{i}}$$

In some embodiments the free-end homotopy can display symmetry where h(x₁, x₂)=h(x₂, x₁), h(x₁, x₁)=S. In these embodiments, using the symmetry can allow the a2a mode to be calculated as the product of the a2a modes of all agent pairs excluding self-pairs as H∈h^{N·(N-1)/2}. In other embodiments, the scene modes including the a2a and/or a2l scene modes can be used to communicate with a large language model (LLM), which is described in more detail below. In some embodiments, the a2l and/or a2a modes can be identifiable from future trajectories of the agents. In another embodiment, margins can be calculated for each of the a2l and/or a2a modes. For example, the margins can be denoted as [symbol] ₁ for a2l modes and M for a2a modes. In scenarios with unitary a2l modes, [symbol] ₁ can be [symbol] ₁∈ [symbol] , where [symbol] ₁(xᵢ, lⱼ)>0 can indicate that agent I is on lane j. [symbol] ₕ can be determined using [symbol] ₕ(xᵢ, xⱼ)∈ [symbol] ³ where [symbol] ₁(xᵢ, xⱼ) has one positive entry and two negative entries. However, in scenarios where the angular distance is equal to the fixed threshold (e.g., \hat{θ}, etc.), [symbol] ₁(xᵢ,xⱼ) one positive entry and two negative entries may not be permitted.

In embodiments, the encoder 308 can encode the static features and agent histories to generate three predictions, the marginal log probability over a2l modes, denoted by p_{L} and referred to as lane mode distribution 312, the marginal probability over a2a modes, denoted by p_{H} and referred to as homotopy distribution 314, and joint scene mode distribution 316 over the joint scene mode. In embodiments, unitary a2l modes, p_{L} can be determined using p_{L}∈ [symbol] ^{N·M} and p_{H} can be determined using p_{H}∈ [symbol] ^{3N·(N-1)/2}. In some embodiments, p_{L} and p_{H} can be directly trained/updated as classification tasks with a cross-entropy loss. Joint scene mode distribution 316 can be calculated using |SM|=M^{N}×3^{N·(N-1)/2}. To reduce the computational requirements when calculating the joint scene mode distribution using this equation, rather than directly output the whole probability distribution over the joint scene modes, a function can be trained/updated to take in a scene mode to output an unnormalized log-likelihood. The function can be trained/updated on scene mode samples 328 with the objective to maximize the likelihood of the ground truth scene mode after normalization. To generate scene mode samples 328, importance sampling can be applied. The joint scene mode can be decomposed into N a2l factors, using the unitary a2l modes, and N·(N−1)/2 a2a factors. The marginal distributions of the a2l factors and/or the a2a factors can also be learned during the training/updating process.

In embodiments, the training/updating process is a 2-stage process. For example, the first stage can include scoring the a2l factors and/or the a2a factors based at least on the distance of the agents and/or lane segments from the vehicle, the distance between the agents and the lane segments for a2l factors, and a level of concentration of the marginal distribution (e.g., lane mode distribution 312 and/or homotopy distribution 314), which can prioritize factors that are not dominated by a single mode. Any unselected factors can then be associated with (e.g., fixed to) their most likely mode and the top K joint modes can be selected from the tensor product of the marginal likelihood. In some embodiments, when selecting the top K joint modes, for at least one (e.g., each) agent of each joint mode, the encoder/decoder model can set the probability of any surrounding neighbors of an agent equal to the probability of the ground truth lane mode. This can allow decoder 322 to generate more accurate trajectory predictions 324.

In some embodiments the joint probability calculated from the marginal distribution can be an approximation for importance sampling. Utilizing the predicted unnormalized log-likelihood for scene mode samples 328, the join mode loss is a cross-entropy loss and can be calculated using the following equation:

$${ℒ}_{S M} = - log ( \frac{exp ( g ( S {M}_{0} ) )}{{\sum }_{i = 1}^{K} exp ( g ( S {M}_{i} ) )} ) ,$$

Where g(·) can be the energy function that maps a scene mode sample to the unnormalized log-likelihood and {SM}ᵢ₌₁^{K} can be scene mode samples 328 where SM₀ can be the ground truth scene mode.

Once the joint scene mode distribution 316 is calculated by encoder 308, the decoder 322 can choose scene mode samples 328, which can be different from scene mode samples 328 used for calculating the joint scene mode loss. The decoder 322 can then condition trajectory predictions 324 on scene mode samples 328. During training/updating, the scene mode samples 328 can be ground truth scene mode 326, and all other scene modes are diverse samples that differ from the ground truth scene mode in a2l and/or a2a modes. The decoding loss function includes a reconstruction loss, denoted by loss [symbol] _{recon}, and two consistency losses. The reconstruction loss can only be applied to the decoded trajectories under the ground truth scene mode and can be calculated as the distance to the ground truth future trajectories of the agents, denoted as L2. In some examples, the two consistency losses are on a2l modes and/or a2a modes. Specifically, one of the two consistency losses can be calculated using the following equation:

$${ℒ}_{L , c o n} = {\sum }_{k = 1}^{K} {\sum }_{i = 1}^{N} {\sum }_{j = 1}^{M} ReLU ( - {1}^{k} [ i , j ] \cdot {ℳ}_{1} ( {\hat{x}}_{i}^{k} , {l}_{j} ) ) ,$$

Where \hat{x}^{k} can be the trajectory prediction from the encoder under scene mode sample k. In some embodiments, [symbol] _{L,con} can penalize negative margins for the agent-lane pairs labeled true in scene mode samples 328. Similarly, the second of the two consistence losses can be calculated using the following equation:

$${ℒ}_{H , con} = {\sum }_{k = 1}^{K} {\sum }_{i = 1}^{N} {\sum }_{j = 1}^{N} ReLU ( - 〈 {h}^{k} [ i , j ] , {ℳ}_{h} ( {\hat{x}}_{i}^{k} , {\hat{x}}_{i}^{k} ) 〉 ) ,$$

In some embodiments, [symbol] _{H,con} can penalize the negative margins for the selected homotopy classes. The total training/updating loss can then be calculated using:

$$ℒ = {ℒ}_{L} + {ℒ}_{H} + {ℒ}_{S M} + {ℒ}_{r e c o n} + {ℒ}_{L , con} + {ℒ}_{H , con} + {ℒ}_{r e g} ,$$

where [symbol] _{L} and [symbol] _{H} can be classification losses for the two marginal distributions, [symbol] _{SM} can be the joint scene mode classification loss, [symbol] _{recon} can be the reconstruction loss under the ground truth scene mode, and [symbol] _{L,con} and [symbol] _{H,con} can be the two consistency losses. [symbol] _{reg} can contain regularization terms such as the L2 regularization, collision losses, control input regularization, etc.

The architecture of the encoder 308 can be based at least on attention-based models (e.g., can include some or all of the components of a transformer) and/or graphical neural networks (GNNs). Due to the scene features involving multiple variables with multiple axes (e.g., the temporal axis, the agent axis, the lane segment axis, etc.) a message passing application programming interface (API) can be utilized to pass messages for any combination of the variables on any of the shared axis. For example, the message passing can be accomplished using attention and/or operations implemented in accordance with the GNN. In some embodiments, there can be two types of variables: node variables and/or edge variables. For examples, the node variables can include an agent history 304 (that are the same as, or similar to, the agent history 512 of FIG. 5), an agent future (e.g., that is the same as, or similar to, the agent future 516 of FIG. 5), and lane segments (e.g., that are the same as, or similar to, the lane segments 510 of FIG. 5), while the edge variables can include a2l edges (e.g., that are the same as, or similar to, the a2l edges 508 of FIG. 5) and a2a edges (e.g., that are the same as, or similar to, the a2a edges 514 of FIG. 5). Both variables can be embedded from raw features with a shared embedding dimension, denoted as de, which can be fixed or dynamic (e.g., changing) with message passing or attention updates.

In some embodiments, the classification module 310 can include a2l mode prediction heads and/or a2a mode prediction heads along with a joint scene mode prediction head. The a2l and a2a mode prediction heads can be based at least on the a2l and a2a edges, which can include dimensionalities of [N, M, Tₕ] and [N, N, Tₕ] respectively, where Tₕ is the number of history frames. In other embodiments, a pooling operation can combine the time dimension and pass them through two multilayer perceptron (MLP) to obtain the log-likelihood of the a2l and a2a edges. In some embodiments, the unitary a2l mode can be used. In another embodiment, the a2a feature can be averaged with its transpose before passing it through the MLP, hence log [symbol] (H)∈ [symbol] ^{N·(N-1)/2}.

In other embodiments, the selected scene mode samples 328 can first be decomposed into a2l and a2a modes, then both modes can be embedded using two embeddings and can be concatenated with the a2l and a2a edges from the encoder 308, where the raw edge features from the encoder 308 are tiled to accommodate multiple scene mode samples 328. Then, a GNN can be implemented to perform several rounds of message passing before the edges are pooled on all three axes (T, A, and L) to obtain a scalar for each scene mode sample, which can be treated as unnormalized log-likelihoods for the joint scene mode samples.

The decoder 322 can use a similar architecture as encoder 308; however, the agent future trajectories can be unknown when performing attention of GNN updates. In some embodiments, an autoregressive procedure can be used to mask out the unknown future blocks or, in other embodiments, the whole trajectory can be decoded in one-shot. The auto regressive procedure can result in the decoder 322 running encoder 308 one step at a time, masking all blocks beyond a set time stamp. After each step, the decoder 322 can generate the position and heading of the agents of the specific time stamp and update the current block, including the auxiliary variables. In embodiments where the trajectory is decoded in one shot, the auxiliary variables associated with the agents' future blocks can be filled with the current position of the agents. Then, multiple rounds of decoding can be performed, and the auxiliary variables can be updated after a (e.g., each) round of decoding. The conditioned a2l modes and a2a modes can then be appended to the custom edge that enters the multi-head attention.

In some embodiments, the decoder 322 can implement a plurality of rounds of decoding, and update the blocks and auxiliary variables after a (e.g., each) round. In these embodiments, the decoder 322 can run any number of rounds to increase the accuracy of the encoder/decoder model. For example, decoder 322 can run a total of five rounds.

In other embodiments, trajectory predictions 324 can utilize a unicycle model for agents that are vehicles in the environment and/or cyclists (e.g., motor cyclists, bicyclists, etc.). The unicycle model can represent the vehicles and/or cyclists as a point that can move in a plane with a specific heading or direction. For example, the unicycle model can utilize the relative positioning of the vehicles and/or cyclists as well as the velocity and/or angular velocity to determine how the position of the vehicles and/or cyclists change over time. In embodiments, agents that are determined to be pedestrians can be represented with a modified unicycle model with a small velocity bound.

In embodiments, three aspects of performance can be used to evaluate the performance of the encoder 308 and decoder 322: accuracy, scene consistence, and controllability. The accuracy can be measured using an average displacement error (ADE) and/or a final displacement error (FDE). To achieve a high accuracy, the encoder 308 and decoder 322 can implement long prediction horizons and can use a large number of lane segments within the driving range of agents. The scene consistency can be measured by the collision rates of trajectory predictions 324. For example, the scene consistency can be determined using a geometric computation. The controllability can refer to the ability to generate behaviors conditioned on the scene mode.

Referring now to FIG. 4, a diagram of a process 400 for interfacing with an LLM is shown, in accordance with some embodiments of the present disclosure. Each block of the process 400 described herein comprises a computing process that can be performed using any combination of hardware, firmware, and/or software. For instance, various functions can be carried out by a processor executing instructions stored in memory. The process 400 can also be embodied as computer-usable instructions stored on computer storage media. The methods can be provided by a standalone application, a service or hosted service (standalone or in combination with another hosted service), or a plug-in to another product, to name a few. In addition, the process 400 is described, by way of example, with respect to the environment 100 of FIG. 1. However, the process 400 can additionally or alternatively be executed by any one system, or any combination of systems, including, but not limited to, those described herein.

In some embodiments, the computing process can be carried out by one or more processors contained in a planning system and/or a control system for an autonomous or semi-autonomous machine (e.g., a vehicle that is the same as, or similar to, the vehicle 102 of FIG. 1, vehicle 800 of FIG. 8A-8D, etc.). In some embodiments, the one or more processors can be contained in a perception system for an autonomous or semi-autonomous machine (e.g., the sensors 104, vehicle processor 110, etc. of FIG. 1). In embodiments, the one or more processors can be contained in a system implemented using a robot, an arial system, a medical system, a boating system, a smart area monitoring system, a system for performing deep learning operations, a system for performing simulation operations, and/or a system for generating or presenting virtual reality (VR) content, augmented reality (AR) content, or mixed reality (MR) content. In some embodiments, the one or more processors can be contained in a system for performing digital twin operations, a system implemented using an edge device, a system incorporating one or more virtual machines (VMs), a system for generating synthetic data, a system implemented at least partially in a data center, and/or a system for performing conversational artificial intelligence (AI) operations. In other embodiments, the one or more processors can be contained by a system for performing generative AI operations, a system implementing language models, a system for implementing vision language models (VLMs), a system for implementing large language models (LLMs), a system for hosting one or more real-time streaming applications, a system for performing light transport simulation, a system for performing collaborative content creation for 3D assets, and/or a system implemented at least partially using cloud computing resources.

In some embodiments, the scene modes (e.g., a2a scene mode, a2l scene mode, etc. as described with respect to FIG. 3) can be determined for a given frame associated with operation of a vehicle (e.g., a vehicle that is the same as, or similar to, the vehicle 102 of FIG. 1) and converted to text prompts to be provided to the LLM. For example, at block 402, a vehicle processor (e.g., a vehicle processor that is the same as, or similar to, the vehicle processor 110 of FIG. 1) can implement a perception system as described herein to process sensor data generated by sensors (e.g., sensors that are the same as, or similar to, the sensors 104 of FIG. 1) of the vehicle. The vehicle processor can then implement an encoder and/or a decoder (e.g., that are the same as, or similar to, the encoder 308 and decoder 322 of FIG. 3) as part of a classification module and/or a regression module (e.g., that are the same as, or similar to, the classification module 310 and the regression module 320 of FIG. 3, respectively) to obtain and process the output of the perception system and generate an output indicating a scene description and/or trajectory predictions. In this example, the scene description can be based at least on a joint scene mode distribution (e.g., that is the same as, or similar to, the joint scene mode distribution 316 of FIG. 3) and/or trajectory predictions (e.g., that are the same as, or similar to, the trajectory predictions 324 of FIG. 3), representing the road geometry, relevant agents, and relevant lane segments. The vehicle processor can then generate a text representation of the scene description.

Process 400, at block 404, the vehicle processor can implement a categorical module that is the same as, or similar to, the classification module 310 of FIG. 3 and/or the regression module 320 of FIG. 3 to generate the text representation of the scene description. The categorical module can be configured to determine one or more candidate scene modes, which specify the a2a and a2l modes as described herein. In the example illustrated in FIG. 4, the candidate scene modes can include the ego vehicle not yielding to the ambulance, the ego vehicle merging to a different lane, and the ego vehicle not yielding to the ambulance (illustrated from left to right). At block 406, the vehicle processor can then generate text inputs based at least on the categorical module and/or regression module and provide the text inputs representing the scene modes as an input to the LLM.

In some embodiments, the LLM can obtain and process the text inputs representing the scene modes to determine an output. For example, the LLM can process the text inputs to generate one or more recommended vehicle maneuvers based at least on the scene modes represented by the text inputs and one or more traffic scenarios and/or traffic codes learned during training/updating of the LLM. For example, the LLM can obtain the text inputs representing the scene modes and generate a text output representing a recommendation that the ego vehicle merge to the left lane to ensure the ambulance is given the right-of-way.

In some embodiments, the LLM can include a neural network (e.g., a transformer-based neural network) and be implemented to predict the likelihood of a sequence of words in a given context. During training/updating, the LLM can processes vast amounts of text data (including text data representing traffic scenarios and/or traffic codes), learning the statistical patterns, grammar, and semantics by adjusting its internal parameters through backpropagation and gradient descent. The LLM also employs attention mechanisms to weigh the importance of different words in the input sequence, allowing the LLM to identify long-range dependencies and context established by the text inputs. Once trained, the LLM generates text by sampling from the probability distribution it has learned for each subsequent word, conditional on the words that have come before, thereby producing coherent and contextually relevant sentences.

Process 400, at block 408 the vehicle processor can provide input to the categorical module and/or regression module to cause them to generate a second output. The second output can include an indication of the probabilities of each of the scene modes occurring based at least on historic data (e.g., agent history that is the same as, or similar to, the agent history 304 of FIG. 3) collected by the perception system. In examples, the vehicle processor can then generate a second text input based at least on the output of the categorical module and/or regression module and provide the second text input to the LLM to cause the LLM to generate a second text output.

Process 400, at block 410 can include the LLM processing the second text input based at least on the probabilities of each of the scene modes occurring to provide an output representing a new suggestion. For example, the LLM can generate a second text output representing a recommendation that the ego vehicle slow down, maintain its lane, and allow the ambulance to merge based at least on the probabilities of each of the scene modes and/or the first text input. In embodiments, the LLM can be trained/updated on traffic data to allow the LLM to provide suggestions to the categorical module and/or regression module that best align with the traffic laws.

Referring now to FIG. 5, a diagram of example interactions between nodes (including scalars scalers representing node variables) and edges (including scalars scalers representing edge variables) of the system of FIG. 3 is shown, in accordance with some embodiments of the present disclosure. More specifically, system 500 shows specific variables included in the node variables (e.g., agent history 512, agent future 516, lane segment 510, etc.) and edge variables (e.g., a2l edge 508, a2a edge 514, etc.) along with the interactions between them, including GNN message passing 502a-d, referred to collectively as message passing 502, self-attention 506a-c, referred to collectively as self-attention 506, and cross-attention 504a-b, referred to collectively as cross-attention 504. In some embodiments, the GNN can share node variables with a transformer, and the GNN message passing 502 and attention updates can be scheduled in an arbitrary order.

In some embodiments, the GNN message passing 502 can contain two types of updates. For example, an edge update can first concatenate the edge embedding with the two connected node embeddings. The concatenated edge embedding can then be passed through an MLP with a residual connection. A node update can also concatenate a node embedding with all the connected edge embeddings of a certain type, which can then be passed through the MLP, a pooling layer, and a residual connection. In some embodiments, multi-head attention can be used as the pooling layer with a learnable query token.

The system 500 can utilize custom edge embeddings that allow the system 500 to process different variable types. For example, the node embeddings can be generated using local information with or without the use of global coordinates. For agents, the agent types, sizes, and non-coordinate states such as velocity, acceleration, and yaw rate can be concatenated, and the raw features can be embedded. Lane segments 510 (e.g., that are the same as, or similar to, the lane segments 306, etc.) can be represented as polylines consisting of multiple waypoints. The local coordinate frame can be centered at the first lane point to represent the shape of the polyline for embedding. In some embodiments, while the node embedding does not include global positioning, the global coordinates can be stored in the vehicle for the agent nodes and the lane nodes. In addition, the custom edge function with the auxiliary variable as inputs can be utilized to embed the relative position between the two nodes it connects. Specifically:

$$q = {F}_{q} ( x ) ,$$

$$k = {F}_{k} ( Concat [ y , {E}_{x y} ( {x}^{a u x} , {y}^{a u x} ) ] )$$

$$v = {F}_{v} ( Concat [ y , {E}_{x y} ( {x}^{a u x} , {y}^{a u x} ) ] )$$

$$Attn ( x , y ) = Softmax ( {q}^{T} k / \sqrt{{d}_{k}} ) v$$

Where F_{q,k,v} are MLPs, x^{aux} is the auxiliary variable associated with x, which can be any node variable, E_{xy} is the custom edge function for the edge type xy. In some embodiments, the custom edge functions can be defined for each type of edge. For example, the a2a edge function can calculate the relative position in the local coordinate frame, the a2l edge function output can contain the project of the agent's position on the lane polyline as well as the starting and ending points of the lane segment in the agent coordinate frame. In some embodiments, the custom edge function can be implemented (e.g., called) during attention calculation and the auxiliary variables are not able to enter the node embedding. In other embodiments, the attention over the time axis can be determined using a learnable embedding as a positional embedding.

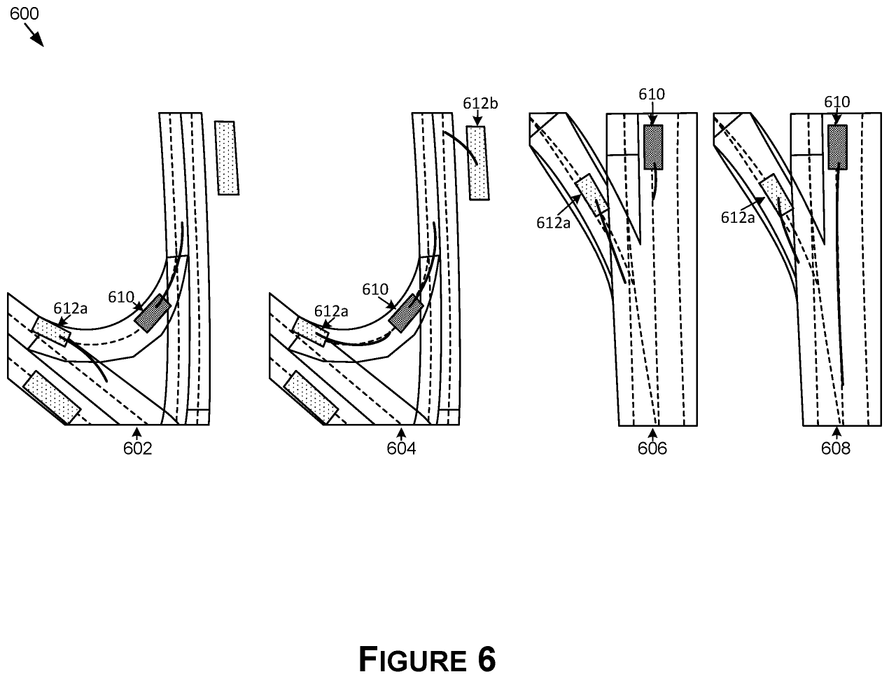

Referring now to FIG. 6, is a diagram 600 of scene mode conditioned prediction trajectories (e.g., trajectory predictions that are the same as, or similar to, the trajectory predictions 324 of FIG. 3) generated by a model is shown, in accordance with some embodiments of the present disclosure. The diagram 600 can include a first trajectory prediction example 602, a second trajectory prediction example 604, a third trajectory prediction example 606, and a fourth trajectory prediction example 608. The diagram 600 can further include ego vehicle 610, which can be similar to vehicle 102 of FIG. 2, and a first agent 612a and a second agent 612b, which can be referred to collectively as agents 612. Agents 612 can be the same as, or similar to, the one or more agents 106 of FIG. 1.

The first trajectory prediction example 602 and the second trajectory prediction example 604 show a2l modes described above. For example, the first trajectory prediction example 602 shows a trajectory prediction for first agent 612a as continuing along the first road and not taking the off-ramp ego vehicle 610 is on. In another example, the second trajectory prediction example 604 shows a trajectory prediction for first agent 612a as taking the same off-ramp as first agent 612a and a trajectory prediction for second agent 612a as entering the second road from a parked position on the second road's shoulder. In both the first trajectory prediction example 602 and second trajectory prediction example 604 the trajectory of ego vehicle 610 is not changed by the predicted trajectories of agents 612. As a result, ego vehicle continues to merge onto the second road.

The third trajectory prediction example 606 and the fourth trajectory prediction example 608 show the impact of homotopies. In both examples, a first agent 612a is shown merging into a lane where ego vehicle 610 is traveling. In third trajectory prediction example 606, a classification module and/or a regression module (e.g., that are the same as, or similar to, the classification module 310 and/or the regression module 320 of FIG. 3) are implemented to determine that the ego vehicle 610 should slow down and allow first agent 612a to merge in response to the predicted trajectory of first agent 612a, whereas in the fourth trajectory prediction example 608, the it is determined that the ego vehicle 610 should not slow down for the first agent 612a, allowing the first agent 612a to merge behind the ego vehicle 610.

The systems and methods described herein can be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein can be used for a variety of purposes, by way of example and without limitation, for machine control, machine locomotion, machine driving, synthetic data generation, model training/updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments can be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for hosting real-time streaming applications, systems for presenting one or more of virtual reality content, augmented reality content, or mixed reality content, systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice-such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Example Language Models

In at least some embodiments, language models, such as large language models (LLMs) and/or other types of generative artificial intelligence (AI) can be implemented. For example, LLMs can be implemented to obtain scene These models can be capable of understanding, summarizing, translating, and/or otherwise generating text (e.g., natural language text, code, etc.), images, video, computer aided design (CAD) assets, omniverse and/or metaverse file information (e.g., in USD format), and/or the like, based at least on the context provided in input prompts or queries. These language models can be considered “large,” in embodiments, based at least on the models being trained on massive datasets and having architectures with large number of learnable network parameters (weights and biases)—such as millions or billions of parameters. The LLMs/VLMs/etc. can be implemented for summarizing textual data, analyzing and extracting insights from data (e.g., textual, image, video, etc.), and generating new text/image/video/etc. in user-specified styles, tones, and/or formats. The LLMs of the present disclosure can be used exclusively for text processing, in embodiments, whereas in other embodiments, multimodal LLMs can be implemented to accept, understand, and/or generate text along with other types of content like images, audio, and/or video. For example, vision language models (VLMs), or more generally multimodal language models, can be implemented to accept image, video, audio, textual, 3D design (e.g., CAD), and/or other inputs data types and/or to generate or output image, video, audio, textual, 3D design, and/or other output data types.

Various types of LLM/VLM/etc. architectures can be implemented in various embodiments. For example, different architectures can be implemented that use different techniques for understanding and generating outputs-such as text, audio, video, image, etc. In some embodiments, LLM architectures such as recurrent neural networks (RNNs) or long short-term memory networks (LSTMs) can be used, while in other embodiments transformer architectures-such as those that rely on self-attention mechanisms—can be used to understand and recognize relationships between words or tokens. One or more generative processing pipelines that include LLMs can also include one or more diffusion block(s) (e.g., denoisers). The language models of the present disclosure can include encoder and/or decoder block(s). For example, discriminative or encoder-only LLMs like BERT (Bidirectional Encoder Representations from Transformers) can be implemented for tasks that involve language comprehension such as classification, sentiment analysis, question answering, and named entity recognition. As another example, generative or decoder-only LLMs like GPT (Generative Pretrained Transformer) can be implemented for tasks that involve language and content generation such as text completion, story generation, and dialogue generation. LLMs that include both encoder and decoder components like T5 (Text-to-Text Transformer) can be implemented to understand and generate content, such as for translation and summarization. These examples are not intended to be limiting, and any architecture type-including but not limited to those described herein—can be implemented depending on the particular embodiment and the task(s) being performed using the model(s).

In various embodiments, the LLMs/VLMs/etc. can be trained using unsupervised learning, in which an LLM learns patterns from large amounts of unlabeled text/audio/video/image/etc. data. Due to the extensive training/updating, in embodiments, the models can not require task-specific or domain-specific training/updating. LLMs that have undergone extensive pre-training on vast amounts of unlabeled text data can be referred to as foundation models and can be adept at a variety of tasks like question-answering, summarization, filling in missing information, and translation. Some LLMs can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure can be implemented using various model alignment techniques. For example, in some embodiments, guardrails can be implemented to identify improper or undesired inputs (e.g., prompts) and/or outputs of the models. In some non-limiting embodiments, the guardrails implemented can be similar to those described in U.S. Pat. App. No. 18,304,341, filed on Apr. 20, 2023, the contents of which are hereby incorporated by reference in their entirety. In some embodiments, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/VLMs/etc. of the present disclosure can be less likely to output language/text/audio/etc. that can be offensive, vulgar, improper, unsafe, out of domain, and/or otherwise undesired for the particular application/implementation.

In some embodiments, the LLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training/updating, and/or based at least on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., using one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training/updating on a large dataset(s), but also on the expertise or optimized nature of one or more external resources-such as APIs, plug-ins, and/or the like.

In some embodiments, multiple language models (e.g., LLMs/VLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data can be provided with the same input query and prompt (e.g., set of constraints, conditioners, etc.). In one or more embodiments, the language models can be different versions of the same foundation model. In one or more embodiments, at least one language model can be instantiated as multiple agents—e.g., more than one prompt can be provided to constrain, direct, or otherwise influence a style, a content, or a character, etc., of the output provided. In one or more example, non-limiting embodiments, the same language model can be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more embodiments, the output from one language model—or version, instance, or agent—can be provided as input to another language model for further processing and/or validation. In one or more embodiments, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more embodiments, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 7A is a block diagram of an example generative language model system 700 suitable for use in implementing at least some embodiments of the present disclosure. In the example illustrated in FIG. 7A, the generative language model system 700 includes a retrieval augmented generation (RAG) component 792, an input processor 705, a tokenizer 710, an embedding component 720, plug-ins/APIs 795, and a generative language model (LM) 730 (which can include an LLM, a VLM, a multi-modal LM, etc.).

At a high level, the input processor 705 can obtain an input 701 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 730. In some embodiments, the input 701 includes plain text in the form of one or more sentences, paragraphs, and/or documents. Additionally or alternatively, the input 701 can include numerical sequences, precomputed embeddings (e.g., word or sentence embeddings), and/or structured data (e.g., in tabular formats, JSON, or XML). In some implementations in which the generative LM 730 is capable of processing multimodal inputs, the input 701 can combine text with image data, audio data, and/or other types of input data, such as but not limited to those described herein. Taking raw input text as an example, the input processor 705 can prepare raw input text in various ways. For example, the input processor 705 can perform various types of text filtering to remove noise (e.g., special characters, punctuation, HTML tags, stopwords) from relevant textual content. In an example involving stopwords (common words that tend to carry little semantic meaning), the input processor 705 can remove stopwords to reduce noise and focus the generative LM 730 on more meaningful content. The input processor 705 can apply text normalization, for example, by converting all characters to lowercase, removing accents, and/or or handling special cases like contractions or abbreviations to ensure consistency. These are just a few examples, and other types of input processing can be applied.

In some embodiments, a RAG component 792 can be used to retrieve additional information to be used as part of the input 701 or prompt. For example, in some embodiments, the input 701 can be generated using the query or input to the model (e.g., a question, a request, etc.) in addition to data retrieved using the RAG component 792. In some embodiments, the input processor 705 can analyze the input 701 and communicate with the RAG component 792 (or the RAG component 792 can be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 can retrieve-using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 792 can retrieve a prior stored conversation history—or at least a summary thereof—and include the prior conversation history along with the current ask/request as part of the input 701 to the generative LM 730.

The tokenizer 710 can segment the (e.g., processed) text into smaller units (tokens) for subsequent analysis and processing. The tokens can represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy can depend on factors such as the language being processed, the task at hand, and/or characteristics of the training/updating dataset. As such, the tokenizer 710 can convert the (e.g., processed) text into a structured format according to tokenization schema being implemented in the particular embodiment.

The embedding component 720 can use any known embedding technique to transform discrete tokens into (e.g., dense, continuous vector) representations of semantic meaning. For example, the embedding component 720 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data, the input processor 705 can resize the image data to a standard size compatible with format of a corresponding input channel and/or can normalize pixel values to a common range (e.g., 0 to 1) to ensure a consistent representation, and the embedding component 720 can encode the image data using any known technique (e.g., using one or more convolutional neural networks (CNNs) to extract visual features). In some implementations in which the input 701 includes audio data, the input processor 705 can resample an audio file to a consistent sampling rate for uniform processing, and the embedding component 720 can use any known technique to extract and encode audio features-such as in the form of a spectrogram (e.g., a mel-spectrogram). In some implementations in which the input 701 includes video data, the input processor 705 can extract frames or apply resizing to extracted frames, and the embedding component 720 can extract features such as optical flow embeddings or video embeddings and/or can encode temporal information or sequences of frames. In some implementations in which the input 701 includes multimodal data, the embedding component 720 can fuse representations of the different types of data (e.g., text, image, audio) using techniques like early fusion (concatenation), late fusion (sequential processing), attention-based fusion, etc.

The generative LM 730 and/or other components of the generative LLM system 700 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 720 can apply an encoded representation of the input 701 to the generative LM 730, and the generative LM 730 can process the encoded representation of the input 701 to generate an output 790, which can include responsive text and/or other types of data.

As described herein, in some embodiments, the generative LM 730 can be configured to access or use—or capable of accessing or using—plug-ins/APIs 795 (which can include one or more plug-ins, application programming interfaces (APIs), databases, data stores, repositories, etc.). For example, for certain tasks or operations that the generative LM 730 is not ideally suited for, the model can have instructions (e.g., as a result of training/updating, and/or based at least on instructions in a given prompt, such as those retrieved using the RAG component 792) to access one or more plug-ins/APIs 795 (e.g., 3^{rd} party plugins) for help in processing the current input. In such an example, where at least part of a prompt is related to restaurants or weather, the model can access one or more restaurant or weather plug-ins (e.g., using one or more APIs), send at least a portion of the prompt related to the particular plug-in/API 795 to the plug-in/API 795, the plug-in/API 795 can process the information and return an answer to the generative LM 730, and the generative LM 730 can use the response to generate the output 790. This process can be repeated—e.g., recursively—for any number of iterations and using any number of plug-ins/APIs 795 until an output 790 that addresses each ask/question/request/process/operation/etc. from the input 701 can be generated. As such, the model(s) can not only rely on its own knowledge from training/updating on a large dataset(s) and/or from data retrieved using the RAG component 792, but also on the expertise or optimized nature of one or more external resources—such as the plug-ins/APIs 795.

FIG. 7B is a block diagram of an example implementation in which the generative LM 730 includes a transformer encoder-decoder. For example, assume input text such as “Who discovered gravity” is tokenized (e.g., by the tokenizer 710 of FIG. 7A) into tokens such as words, and each token is encoded (e.g., by the embedding component 720 of FIG. 7A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 735 of the generative LM 730.

In an example implementation, the encoder(s) 735 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 740 can convert the context vector into attention vectors (keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 735, in an example transformer architecture, each token (e.g., word) flows through a separate path in the decoder(s) 745. During a first pass, the decoder(s) 745, a classifier 750, and a generation mechanism 755 can generate a first token, and the generation mechanism 755 can apply the generated token as an input during a second pass. The process can repeat in a loop, successively generating and adding tokens (e.g., words) to the output from the preceding pass and applying the token embeddings of the composite sequence with positional encodings as an input to the decoder(s) 745 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 735, except that it creates its queries from the layer below it and takes the keys and values (e.g., matrix) from the output of the encoder(s) 735.

As such, the decoder(s) 745 can output some decoded (e.g., vector) representation of the input being applied during a particular pass. The classifier 750 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 755 can select or sample a word or token based at least on a corresponding predicted probability (e.g., select the word with the highest predicted probability) and append it to the output from a previous pass, generating each word or token sequentially. The generation mechanism 755 can repeat the process, triggering successive decoder inputs and corresponding predictions until selecting or sampling a symbol or token that represents the end of the response, at which point, the generation mechanism 755 can output the generated response.

FIG. 7C is a block diagram of an example implementation in which the generative LM 730 includes a decoder-only transformer architecture. For example, the decoder(s) 760 of FIG. 7C can operate similarly as the decoder(s) 745 of FIG. 7B except each of the decoder(s) 760 of FIG. 7C omits the encoder-decoder self-attention layer (since there is no encoder in this implementation). As such, the decoder(s) 760 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 760. As with the decoder(s) 745 of FIG. 7B, each token (e.g., word) can flow through a separate path in the decoder(s) 760, and the decoder(s) 760, a classifier 765, and a generation mechanism 770 can use auto-regression to sequentially generate one token at a time until predicting a symbol or token that represents the end of the response. The classifier 765 and the generation mechanism 770 can operate similarly as the classifier 750 and the generation mechanism 755 of FIG. 7B, with the generation mechanism 770 selecting or sampling each successive output token based at least on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Autonomous Vehicle

FIG. 8A is an illustration of an example autonomous vehicle 800 (e.g., vehicle 102, etc.), in accordance with some embodiments of the present disclosure. The autonomous vehicle 800 (alternatively referred to herein as the “vehicle 800”) can include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 800 can be capable of functionality in accordance with one or more of Level 3-Level 5 of the autonomous driving levels. The vehicle 800 can be capable of functionality in accordance with one or more of Level 1-Level 5 of the autonomous driving levels. For example, the vehicle 800 can be capable of driver assistance (Level 1), partial automation (Level 2), conditional automation (Level 3), high automation (Level 4), and/or full automation (Level 5), depending on the embodiment. The term “autonomous,” as used herein, can include any and/or all types of autonomy for the vehicle 800 or other machine, such as being fully autonomous, being highly autonomous, being conditionally autonomous, being partially autonomous, providing assistive autonomy, being semi-autonomous, being primarily autonomous, or other designation.

The vehicle 800 can include components such as a chassis, a vehicle body, wheels (e.g., 2, 4, 6, 8, 18, etc.), tires, axles, and other components of a vehicle. The vehicle 800 can include a propulsion system 850, such as an internal combustion engine, hybrid electric power plant, an all-electric engine, and/or another propulsion system type. The propulsion system 850 can be connected to a drivetrain of the vehicle 800, which can include a transmission, to enable the propulsion of the vehicle 800. The propulsion system 850 can be controlled in response to receiving signals from the throttle/accelerator 852.

A steering system 854, which can include a steering wheel, can be used to steer the vehicle 800 (e.g., along a desired path or route) when the propulsion system 850 is operating (e.g., when the vehicle is in motion). The steering system 854 can obtain signals from a steering actuator 856. The steering wheel can be optional for full automation (Level 5) functionality.

The brake sensor system 846 can be used to operate the vehicle brakes in response to receiving signals from the brake actuators 848 and/or brake sensors.

Controller(s) 836, which can include one or more system on chips (SoCs) 804 (FIG. 8C) and/or GPU(s), can provide signals (e.g., representative of commands) to one or more components and/or systems of the vehicle 800. For example, the controller(s) can send signals to operate the vehicle brakes using one or more brake actuators 848, to operate the steering system 854 using one or more steering actuators 856, to operate the propulsion system 850 using one or more throttle/accelerators 852. The controller(s) 836 can include one or more onboard (e.g., integrated) computing devices (e.g., supercomputers) that process sensor signals, and output operation commands (e.g., signals representing commands) to enable autonomous driving and/or to assist a human driver in driving the vehicle 800. The controller(s) 836 can include a first controller 836 for autonomous driving functions, a second controller 836 for functional safety functions, a third controller 836 for artificial intelligence functionality (e.g., computer vision), a fourth controller 836 for infotainment functionality, a fifth controller 836 for redundancy in emergency conditions, and/or other controllers. In some examples, a single controller 836 can handle two or more of the above functionalities, two or more controllers 836 can handle a single functionality, and/or any combination thereof.

The controller(s) 836 can provide the signals for controlling one or more components and/or systems of the vehicle 800 in response to sensor data obtained from one or more sensors (e.g., sensor inputs from one or more sensors 104). The sensor data can be obtained from, for example and without limitation, global navigation satellite systems (“GNSS”) sensor(s) 858 (e.g., Global Positioning System sensor(s)), RADAR sensor(s) 860, ultrasonic sensor(s) 862, LIDAR sensor(s) 864, inertial measurement unit (IMU) sensor(s) 866 (e.g., accelerometer(s), gyroscope(s), magnetic compass(es), magnetometer(s), etc.), microphone(s) 896, stereo camera(s) 868, wide-view camera(s) 870 (e.g., fisheye cameras), infrared camera(s) 872, surround camera(s) 874 (e.g., 360 degree cameras), long-range and/or mid-range camera(s) 898, speed sensor(s) 844 (e.g., for measuring the speed of the vehicle 800), vibration sensor(s) 842, steering sensor(s) 840, brake sensor(s) (e.g., as part of the brake sensor system 846), and/or other sensor types.

One or more of the controller(s) 836 (e.g., vehicle processor 110) can obtain inputs (e.g., represented by input data) from an instrument cluster 832 of the vehicle 800 and provide outputs (e.g., represented by output data, display data, etc.) using a human-machine interface (HMI) display 834, an audible annunciator, a loudspeaker, and/or using other components of the vehicle 800. The outputs can include information such as vehicle velocity, speed, time, map data (e.g., the High Definition (“HD”) map 822 of FIG. 8C), location data (e.g., the vehicle's 800 location, such as on a map), direction, location of other vehicles (e.g., an occupancy grid), information about objects and status of objects as perceived by the controller(s) 836, etc. For example, the HMI display 834 can display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 800 further includes a network interface 824 which can use one or more wireless antenna(s) 826 and/or modem(s) to communicate over one or more networks. For example, the network interface 824 can be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 826 can also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 8B is an example of camera locations and fields of view for the example autonomous vehicle 800 of FIG. 8A, in accordance with some embodiments of the present disclosure. The cameras and respective fields of view are one example embodiment and are not intended to be limiting. For example, additional and/or alternative cameras can be included and/or the cameras can be located at different locations on the vehicle 800.

The camera types for the cameras can include, but are not limited to, digital cameras that can be adapted for use with the components and/or systems of the vehicle 800. The camera(s) can operate at automotive safety integrity level (ASIL) B and/or at another ASIL. The camera types can be capable of any image capture rate, such as 60 frames per second (fps), 120 fps, 240 fps, etc., depending on the embodiment. The cameras can be capable of using rolling shutters, global shutters, another type of shutter, or a combination thereof. In some examples, the color filter array can include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, can be used in an effort to increase light sensitivity.

In some examples, one or more of the camera(s) can be used to perform advanced driver assistance systems (ADAS) functions (e.g., as part of a redundant or fail-safe design). For example, a Multi-Function Mono Camera can be installed to provide functions including lane departure warning, traffic sign assist and intelligent headlamp control. One or more of the camera(s) (e.g., all of the cameras) can record and provide image data (e.g., video) simultaneously.

One or more of the cameras can be mounted in a mounting assembly, such as a custom designed (three dimensional (“3D”) printed) assembly, in order to cut out stray light and reflections from within the car (e.g., reflections from the dashboard reflected in the windshield mirrors) which can interfere with the camera's image data capture abilities. With reference to wing-mirror mounting assemblies, the wing-mirror assemblies can be custom 3D printed so that the camera mounting plate matches the shape of the wing-mirror. In some examples, the camera(s) can be integrated into the wing-mirror. For side-view cameras, the camera(s) can also be integrated within the four pillars at each corner of the cabin.

Cameras with a field of view that include portions of the environment in front of the vehicle 800 (e.g., front-facing cameras) can be used for surround view, to help identify forward facing paths and obstacles, as well aid in, with the help of one or more controllers 836 and/or control SoCs, providing information critical to generating an occupancy grid and/or determining the preferred vehicle paths. Front-facing cameras can be used to perform many of the same ADAS functions as LIDAR, including emergency braking, pedestrian detection, and collision avoidance. Front-facing cameras can also be used for ADAS functions and systems including Lane Departure Warnings (“LDW”), Autonomous Cruise Control (“ACC”), and/or other functions such as traffic sign recognition.

A variety of cameras can be used in a front-facing configuration, including, for example, a monocular camera platform that includes a complementary metal oxide semiconductor (“CMOS”) color imager. Another example can be a wide-view camera(s) 870 that can be used to perceive objects coming into view from the periphery (e.g., pedestrians, crossing traffic or bicycles). Although only one wide-view camera is illustrated in FIG. 8B, there can be any number (including zero) of wide-view cameras 870 on the vehicle 800. In addition, any number of long-range camera(s) 898 (e.g., a long-view stereo camera pair) can be used for depth-based object detection, especially for objects for which a neural network has not yet been trained/updated. The long-range camera(s) 898 can also be used for object detection and classification, as well as basic object tracking.

Any number of stereo cameras 868 can also be included in a front-facing configuration. In at least one embodiment, one or more of stereo camera(s) 868 can include an integrated control unit comprising a scalable processing unit, which can provide a programmable logic (“FPGA”) and a multi-core micro-processor with an integrated Controller Area Network (“CAN”) or Ethernet interface on a single chip. Such a unit can be used to generate a 3D map of the vehicle's environment, including a distance estimate for all the points in the image. An alternative stereo camera(s) 868 can include a compact stereo vision sensor(s) that can include two camera lenses (one each on the left and right) and an image processing chip that can measure the distance from the vehicle to the target object and use the generated information (e.g., metadata) to activate the autonomous emergency braking and lane departure warning functions. Other types of stereo camera(s) 868 can be used in addition to, or alternatively from, those described herein.

Cameras with a field of view that include portions of the environment to the side of the vehicle 800 (e.g., side-view cameras) can be used for surround view, providing information used to create and update the occupancy grid, as well as to generate side impact collision warnings. For example, surround camera(s) 874 (e.g., four surround cameras 874 as illustrated in FIG. 8B) can be positioned to on the vehicle 800. The surround camera(s) 874 can include wide-view camera(s) 870, fisheye camera(s), 360 degree camera(s), etc. Four example, four fisheye cameras can be positioned on the vehicle's front, rear, and sides. In an alternative arrangement, the vehicle can use three surround camera(s) 874 (e.g., left, right, and rear), and can leverage one or more other camera(s) (e.g., a forward-facing camera) as a fourth surround view camera.

Cameras with a field of view that include portions of the environment to the rear of the vehicle 800 (e.g., rear-view cameras) can be used for park assistance, surround view, rear collision warnings, and creating and updating the occupancy grid. A wide variety of cameras can be used including, but not limited to, cameras that are also suitable as a front-facing camera(s) (e.g., long-range and/or mid-range camera(s) 898, stereo camera(s) 868), infrared camera(s) 872, etc.), as described herein.

FIG. 8C is a block diagram of an example system architecture for the example autonomous vehicle 800 of FIG. 8A, in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory.

Each of the components, features, and systems of the vehicle 800 in FIG. 8C are illustrated as being connected using bus 802. The bus 802 can include a Controller Area Network (CAN) data interface (alternatively referred to herein as a “CAN bus”). A CAN can be a network inside the vehicle 800 used to aid in control of various features and functionality of the vehicle 800, such as actuation of brakes, acceleration, braking, steering, windshield wipers, etc. A CAN bus can be configured to have dozens or even hundreds of nodes, each with its own unique identifier (e.g., a CAN ID). The CAN bus can be read to find steering wheel angle, ground speed, engine revolutions per minute (RPMs), button positions, and/or other vehicle status indicators. The CAN bus can be ASIL B compliant.

Although the bus 802 is described herein as being a CAN bus, this is not intended to be limiting. For example, in addition to, or alternatively from, the CAN bus, FlexRay and/or Ethernet can be used. Additionally, although a single line is used to represent the bus 802, this is not intended to be limiting. For example, there can be any number of busses 802, which can include one or more CAN busses, one or more FlexRay busses, one or more Ethernet busses, and/or one or more other types of busses using a different protocol. In some examples, two or more busses 802 can be used to perform different functions, and/or can be used for redundancy. For example, a first bus 802 can be used for collision avoidance functionality and a second bus 802 can be used for actuation control. In any example, each bus 802 can communicate with any of the components of the vehicle 800, and two or more busses 802 can communicate with the same components. In some examples, each SoC 804, each controller 836, and/or each computer within the vehicle can have access to the same input data (e.g., inputs from sensors of the vehicle 800), and can be connected to a common bus, such the CAN bus.

The vehicle 800 can include one or more controller(s) 836, such as those described herein with respect to FIG. 8A. The controller(s) 836 can be used for a variety of functions. The controller(s) 836 can be coupled to any of the various other components and systems of the vehicle 800, and can be used for control of the vehicle 800, artificial intelligence of the vehicle 800, infotainment for the vehicle 800, etc.

The vehicle 800 can include a system(s) on a chip (SoC) 804. The SoC 804 can include CPU(s) 806, GPU(s) 808, processor(s) 810, cache(s) 812, accelerator(s) 814, data store(s) 816, and/or other components and features not illustrated. The SoC(s) 804 can be used to control the vehicle 800 in a variety of platforms and systems. For example, the SoC(s) 804 can be combined in a system (e.g., the system of the vehicle 800) with an HD map 822 which can obtain map refreshes and/or updates using a network interface 824 from one or more servers (e.g., server(s) 878 of FIG. 8D).

The CPU(s) 806 can include a CPU cluster or CPU complex (alternatively referred to herein as a “CCPLEX”). The CPU(s) 806 can include multiple cores and/or L2 caches. For example, in some embodiments, the CPU(s) 806 can include eight cores in a coherent multi-processor configuration. In other embodiments, the CPU(s) 806 can include four dual-core clusters where each cluster has a dedicated L2 cache (e.g., a 2 MB L2 cache). The CPU(s) 806 (e.g., the CCPLEX) can be configured to support simultaneous cluster operation enabling any combination of the clusters of the CPU(s) 806 to be active at any given time.

The CPU(s) 806 can implement power management capabilities that include one or more of the following features: individual hardware blocks can be clock-gated automatically when idle to save dynamic power; each core clock can be gated when the core is not actively executing instructions due to execution of WFI/WFE instructions; each core can be independently power-gated; each core cluster can be independently clock-gated when all cores are clock-gated or power-gated; and/or each core cluster can be independently power-gated when all cores are power-gated. The CPU(s) 806 can further implement an enhanced algorithm for managing power states, where allowed power states and expected wakeup times are specified, and the hardware/microcode determines the best power state to enter for the core, cluster, and CCPLEX. The processing cores can support simplified power state entry sequences in software with the work offloaded to microcode.

The GPU(s) 808 can include an integrated GPU (alternatively referred to herein as an “iGPU”). The GPU(s) 808 can be programmable and can be efficient for parallel workloads. The GPU(s) 808, in some examples, can use an enhanced tensor instruction set. The GPU(s) 808 can include one or more streaming microprocessors, where each streaming microprocessor can include an L1 cache (e.g., an L1 cache with at least 96 KB storage capacity), and two or more of the streaming microprocessors can share an L2 cache (e.g., an L2 cache with a 512 KB storage capacity). In some embodiments, the GPU(s) 808 can include at least eight streaming microprocessors. The GPU(s) 808 can use compute application programming interface(s) (API(s)). In addition, the GPU(s) 808 can use one or more parallel computing platforms and/or programming models (e.g., NVIDIA's CUDA).

The GPU(s) 808 can be power-optimized for best performance in automotive and embedded use cases. For example, the GPU(s) 808 can be fabricated on a Fin field-effect transistor (FinFET). However, this is not intended to be limiting and the GPU(s) 808 can be fabricated using other semiconductor manufacturing processes. Each streaming microprocessor can incorporate a number of mixed-precision processing cores partitioned into multiple blocks. For example, and without limitation, 64 PF32 cores and 32 PF64 cores can be partitioned into four processing blocks. In such an example, each processing block can be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors can include independent parallel integer and floating-point data paths to provide for efficient execution of workloads with a mix of computation and addressing calculations. The streaming microprocessors can include independent thread scheduling capability to enable finer-grain synchronization and cooperation between parallel threads. The streaming microprocessors can include a combined L1 data cache and shared memory unit in order to improve performance while simplifying programming.

The GPU(s) 808 can include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) can be used, such as a graphics double data rate type five synchronous random-access memory (GDDR5).

The GPU(s) 808 can include unified memory technology including access counters to allow for more accurate migration of memory pages to the processor that accesses them most frequently, thereby improving efficiency for memory ranges shared between processors. In some examples, address translation services (ATS) support can be used to allow the GPU(s) 808 to access the CPU(s) 806 page tables directly. In such examples, when the GPU(s) 808 memory management unit (MMU) experiences a miss, an address translation request can be transmitted to the CPU(s) 806. In response, the CPU(s) 806 can look in its page tables for the virtual-to-physical mapping for the address and transmits the translation back to the GPU(s) 808. As such, unified memory technology can allow a single unified virtual address space for memory of both the CPU(s) 806 and the GPU(s) 808, thereby simplifying the GPU(s) 808 programming and porting of applications to the GPU(s) 808.

In addition, the GPU(s) 808 can include an access counter that can keep track of the frequency of access of the GPU(s) 808 to memory of other processors. The access counter can help ensure that memory pages are moved to the physical memory of the processor that is accessing the pages most frequently.

The SoC(s) 804 can include any number of cache(s) 812, including those described herein. For example, the cache(s) 812 can include an L3 cache that is available to both the CPU(s) 806 and the GPU(s) 808 (e.g., that is connected both the CPU(s) 806 and the GPU(s) 808). The cache(s) 812 can include a write-back cache that can keep track of states of lines, such as by using a cache coherence protocol (e.g., MEI, MESI, MSI, etc.). The L3 cache can include 4 MB or more, depending on the embodiment, although smaller cache sizes can be used.

The SoC(s) 804 can include an arithmetic logic unit(s) (ALU(s)) which can be leveraged in performing processing with respect to any of the variety of tasks or operations of the vehicle 800—such as processing DNNs. In addition, the SoC(s) 804 can include a floating point unit(s) (FPU(s))—or other math coprocessor or numeric coprocessor types—for performing mathematical operations within the system. For example, the SoC(s) 804 can include one or more FPUs integrated as execution units within a CPU(s) 806 and/or GPU(s) 808.

The SoC(s) 804 can include one or more accelerators 814 (e.g., hardware accelerators, software accelerators, or a combination thereof). For example, the SoC(s) 804 can include a hardware acceleration cluster that can include optimized hardware accelerators and/or large on-chip memory. The large on-chip memory (e.g., 4 MB of SRAM), can enable the hardware acceleration cluster to accelerate neural networks and other calculations. The hardware acceleration cluster can be used to complement the GPU(s) 808 and to off-load some of the tasks of the GPU(s) 808 (e.g., to free up more cycles of the GPU(s) 808 for performing other tasks). As an example, the accelerator(s) 814 can be used for targeted workloads (e.g., perception, convolutional neural networks (CNNs), etc.) that are stable enough to be amenable to acceleration. The term “CNN,” as used herein, can include all types of CNNs, including region-based or regional convolutional neural networks (RCNNs) and Fast RCNNs (e.g., as used for object detection).

The accelerator(s) 814 (e.g., the hardware acceleration cluster) can include a deep learning accelerator(s) (DLA). The DLA(s) can include one or more Tensor processing units (TPUs) that can be configured to provide an additional ten trillion operations per second for deep learning applications and inferencing. The TPUs can be accelerators configured to, and optimized for, performing image processing functions (e.g., for CNNs, RCNNs, etc.). The DLA(s) can further be optimized for a specific set of neural network types and floating point operations, as well as inferencing. The design of the DLA(s) can provide more performance per millimeter than a general-purpose GPU, and vastly exceeds the performance of a CPU. The TPU(s) can perform several functions, including a single-instance convolution function, supporting, for example, INT8, INT16, and FP16 data types for both features and weights, as well as post-processor functions.

The DLA(s) can quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) can perform any function of the GPU(s) 808, and by using an inference accelerator, for example, a designer can target either the DLA(s) or the GPU(s) 808 for any function. For example, the designer can focus processing of CNNs and floating point operations on the DLA(s) and leave other functions to the GPU(s) 808 and/or other accelerator(s) 814.

The accelerator(s) 814 (e.g., the hardware acceleration cluster) can include a programmable vision accelerator(s) (PVA), which can alternatively be referred to herein as a computer vision accelerator. The PVA(s) can be designed and configured to accelerate computer vision algorithms for the advanced driver assistance systems (ADAS), autonomous driving, and/or augmented reality (AR) and/or virtual reality (VR) applications. The PVA(s) can provide a balance between performance and flexibility. For example, each PVA(s) can include, for example and without limitation, any number of reduced instruction set computer (RISC) cores, direct memory access (DMA), and/or any number of vector processors.

The RISC cores can interact with image sensors (e.g., the image sensors of any of the cameras described herein), image signal processor(s), etc. Each of the RISC cores can include any amount of memory. The RISC cores can use any of a number of protocols, depending on the embodiment. In some examples, the RISC cores can execute a real-time operating system (RTOS). The RISC cores can be implemented using one or more integrated circuit devices, application specific integrated circuits (ASICs), and/or memory devices. For example, the RISC cores can include an instruction cache and/or a tightly coupled RAM.

The DMA can enable components of the PVA(s) to access the system memory independently of the CPU(s) 806. The DMA can support any number of features used to provide optimization to the PVA including, but not limited to, supporting multi-dimensional addressing and/or circular addressing. In some examples, the DMA can support up to six or more dimensions of addressing, which can include block width, block height, block depth, horizontal block stepping, vertical block stepping, and/or depth stepping.

The vector processors can be programmable processors that can be designed to efficiently and flexibly execute programming for computer vision algorithms and provide signal processing capabilities. In some examples, the PVA can include a PVA core and two vector processing subsystem partitions. The PVA core can include a processor subsystem, DMA engine(s) (e.g., two DMA engines), and/or other peripherals. The vector processing subsystem can operate as the primary processing engine of the PVA, and can include a vector processing unit (VPU), an instruction cache, and/or vector memory (e.g., VMEM). A VPU core can include a digital signal processor such as, for example, a single instruction, multiple data (SIMD), very long instruction word (VLIW) digital signal processor. The combination of the SIMD and VLIW can enhance throughput and speed.

Each of the vector processors can include an instruction cache and can be coupled to dedicated memory. As a result, in some examples, each of the vector processors can be configured to execute independently of the other vector processors. In other examples, the vector processors that are included in a particular PVA can be configured to employ data parallelism. For example, in some embodiments, the plurality of vector processors included in a single PVA can execute the same computer vision algorithm, but on different regions of an image. In other examples, the vector processors included in a particular PVA can simultaneously execute different computer vision algorithms, on the same image, or even execute different algorithms on sequential images or portions of an image. Among other things, any number of PVAs can be included in the hardware acceleration cluster and any number of vector processors can be included in each of the PVAs. In addition, the PVA(s) can include additional error correcting code (ECC) memory, to enhance overall system safety.

The accelerator(s) 814 (e.g., the hardware acceleration cluster) can include a computer vision network on-chip and SRAM, for providing a high-bandwidth, low latency SRAM for the accelerator(s) 814. In some examples, the on-chip memory can include at least 4 MB SRAM, consisting of, for example and without limitation, eight field-configurable memory blocks, that can be accessible by both the PVA and the DLA. Each pair of memory blocks can include an advanced peripheral bus (APB) interface, configuration circuitry, a controller, and a multiplexer. Any type of memory can be used. The PVA and DLA can access the memory using a backbone that provides the PVA and DLA with high-speed access to memory. The backbone can include a computer vision network on-chip that interconnects the PVA and the DLA to the memory (e.g., using the APB).

The computer vision network on-chip can include an interface that determines, before transmission of any control signal/address/data, that both the PVA and the DLA provide ready and valid signals. Such an interface can provide for separate phases and separate channels for transmitting control signals/addresses/data, as well as burst-type communications for continuous data transfer. This type of interface can comply with ISO 26262 or IEC 61508 standards, although other standards and protocols can be used.

In some examples, the SoC(s) 804 can include a real-time ray-tracing hardware accelerator, such as described in U.S. patent application Ser. No. 16/101,232, filed on Aug. 10, 2018. The real-time ray-tracing hardware accelerator can be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) can be used for executing one or more ray-tracing related operations.

The accelerator(s) 814 (e.g., the hardware accelerator cluster) have a wide array of uses for autonomous driving. The PVA can be a programmable vision accelerator that can be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm can be used in some examples, although this is not intended to be limiting. Many applications for Level 3-5 autonomous driving require motion estimation/stereo matching on-the-fly (e.g., structure from motion, pedestrian recognition, lane detection, etc.). The PVA can perform computer stereo vision function on inputs from two monocular cameras.

In some examples, the PVA can be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA can be used to run any type of network to enhance control and driving safety, including for example, a neural network that outputs a measure of confidence for each object detection. Such a confidence value can be interpreted as a probability, or as providing a relative “weight” of each detection compared to other detections. This confidence value enables the system to make further decisions regarding which detections should be considered as true positive detections rather than false positive detections. For example, the system can set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA can run a neural network for regressing the confidence value. The neural network can take as its input at least some subset of parameters, such as bounding box dimensions, ground plane estimate obtained (e.g. from another subsystem), inertial measurement unit (IMU) sensor 866 output that correlates with the vehicle 800 orientation, distance, 3D location estimates of the object obtained from the neural network and/or other sensors (e.g., LIDAR sensor(s) 864 or RADAR sensor(s) 860), among others.

The SoC(s) 804 can include data store(s) 816 (e.g., memory). The data store(s) 816 can be on-chip memory of the SoC(s) 804, which can store neural networks to be executed on the GPU and/or the DLA. In some examples, the data store(s) 816 can be large enough in capacity to store multiple instances of neural networks for redundancy and safety. The data store(s) 812 can comprise L2 or L3 cache(s) 812. Reference to the data store(s) 816 can include reference to the memory associated with the PVA, DLA, and/or other accelerator(s) 814, as described herein.

The SoC(s) 804 can include one or more processor(s) 810 (e.g., embedded processors). The processor(s) 810 can include a boot and power management processor that can be a dedicated processor and subsystem to handle boot power and management functions and related security enforcement. The boot and power management processor can be a part of the SoC(s) 804 boot sequence and can provide runtime power management services. The boot power and management processor can provide clock and voltage programming, assistance in system low power state transitions, management of SoC(s) 804 thermals and temperature sensors, and/or management of the SoC(s) 804 power states. Each temperature sensor can be implemented as a ring-oscillator whose output frequency is proportional to temperature, and the SoC(s) 804 can use the ring-oscillators to detect temperatures of the CPU(s) 806, GPU(s) 808, and/or accelerator(s) 814. If temperatures are determined to exceed a threshold, the boot and power management processor can enter a temperature fault routine and put the SoC(s) 804 into a lower power state and/or put the vehicle 800 into a chauffeur to safe stop mode (e.g., bring the vehicle 800 to a safe stop).

The processor(s) 810 can further include a set of embedded processors that can serve as an audio processing engine. The audio processing engine can be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 810 can further include an always on processor engine that can provide necessary hardware features to support low power sensor management and wake use cases. The always on processor engine can include a processor core, a tightly coupled RAM, supporting peripherals (e.g., timers and interrupt controllers), various I/O controller peripherals, and routing logic.

The processor(s) 810 can further include a safety cluster engine that includes a dedicated processor subsystem to handle safety management for automotive applications. The safety cluster engine can include two or more processor cores, a tightly coupled RAM, support peripherals (e.g., timers, an interrupt controller, etc.), and/or routing logic. In a safety mode, the two or more cores can operate in a lockstep mode and function as a single core with comparison logic to detect any differences between their operations.

The processor(s) 810 can further include a real-time camera engine that can include a dedicated processor subsystem for handling real-time camera management.

The processor(s) 810 can further include a high-dynamic range signal processor that can include an image signal processor that is a hardware engine that is part of the camera processing pipeline.

The processor(s) 810 can include a video image compositor that can be a processing block (e.g., implemented on a microprocessor) that implements video post-processing functions needed by a video playback application to produce the final image for the player window. The video image compositor can perform lens distortion correction on wide-view camera(s) 870, surround camera(s) 874, and/or on in-cabin monitoring camera sensors. In-cabin monitoring camera sensor is preferably monitored by a neural network running on another instance of the Advanced SoC, configured to identify in cabin events and respond accordingly. An in-cabin system can perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor can include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor can use information from the previous image to reduce noise in the current image.

The video image compositor can also be configured to perform stereo rectification on input stereo lens frames. The video image compositor can further be used for user interface composition when the operating system desktop is in use, and the GPU(s) 808 is not required to continuously render new surfaces. Even when the GPU(s) 808 is powered on and active doing 3D rendering, the video image compositor can be used to offload the GPU(s) 808 to improve performance and responsiveness.

The SoC(s) 804 can further include a mobile industry processor interface (MIPI) camera serial interface for receiving video and input from cameras, a high-speed interface, and/or a video input block that can be used for camera and related pixel input functions. The SoC(s) 804 can further include an input/output controller(s) that can be controlled by software and can be used for receiving I/O signals that are uncommitted to a specific role.

The SoC(s) 804 can further include a broad range of peripheral interfaces to enable communication with peripherals, audio codecs, power management, and/or other devices. The SoC(s) 804 can be used to process data from cameras (e.g., connected over Gigabit Multimedia Serial Link and Ethernet), sensors (e.g., LIDAR sensor(s) 864, RADAR sensor(s) 860, etc. that can be connected over Ethernet), data from bus 802 (e.g., speed of vehicle 800, steering wheel position, etc.), data from GNSS sensor(s) 858 (e.g., connected over Ethernet or CAN bus). The SoC(s) 804 can further include dedicated high-performance mass storage controllers that can include their own DMA engines, and that can be used to free the CPU(s) 806 from routine data management tasks.

The SoC(s) 804 can be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 804 can be faster, more reliable, and even more energy-efficient and space-efficient than conventional systems. For example, the accelerator(s) 814, when combined with the CPU(s) 806, the GPU(s) 808, and the data store(s) 816, can provide for a fast, efficient platform for level 3-5 autonomous vehicles.

The technology thus provides capabilities and functionality that cannot be achieved by conventional systems. For example, computer vision algorithms can be executed on CPUs, which can be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 820) can include a text and word recognition, allowing the supercomputer to read and understand traffic signs, including signs for which the neural network has not been specifically trained/updated. The DLA can further include a neural network that is able to identify, interpret, and provides semantic understanding of the sign, and to pass that semantic understanding to the path planning modules running on the CPU Complex.

As another example, multiple neural networks can be run simultaneously, as is required for Level 3, 4, or 5 driving. For example, a warning sign consisting of “Caution: flashing lights indicate icy conditions,” along with an electric light, can be independently or collectively interpreted by several neural networks. The sign itself can be identified as a traffic sign by a first deployed neural network (e.g., a neural network that has been trained/updated), the text “Flashing lights indicate icy conditions” can be interpreted by a second deployed neural network, which informs the vehicle's path planning software (preferably executing on the CPU Complex) that when flashing lights are detected, icy conditions exist. The flashing light can be identified by operating a third deployed neural network over multiple frames, informing the vehicle's path-planning software of the presence (or absence) of flashing lights. All three neural networks can run simultaneously, such as within the DLA and/or on the GPU(s) 808.

In some examples, a CNN for facial recognition and vehicle owner identification can use data from camera sensors to identify the presence of an authorized driver and/or owner of the vehicle 800. The always on sensor processing engine can be used to unlock the vehicle when the owner approaches the driver door and turn on the lights, and, in security mode, to disable the vehicle when the owner leaves the vehicle. In this way, the SoC(s) 804 provide for security against theft and/or carjacking.

In another example, a CNN for emergency vehicle detection and identification can use data from microphones 896 to detect and identify emergency vehicle sirens. In contrast to conventional systems, that use general classifiers to detect sirens and manually extract features, the SoC(s) 804 use the CNN for classifying environmental and urban sounds, as well as classifying visual data. In a preferred embodiment, the CNN running on the DLA is trained/updated to identify the relative closing speed of the emergency vehicle (e.g., by using the Doppler Effect). The CNN can also be trained/updated to identify emergency vehicles specific to the local area in which the vehicle is operating, as identified by GNSS sensor(s) 858. Thus, for example, when operating in Europe the CNN will seek to detect European sirens, and when in the United States the CNN will seek to identify only North American sirens. Once an emergency vehicle is detected, a control program can be used to execute an emergency vehicle safety routine, slowing the vehicle, pulling over to the side of the road, parking the vehicle, and/or idling the vehicle, with the assistance of ultrasonic sensors 862, until the emergency vehicle(s) passes.

The vehicle can include a CPU(s) 818 (e.g., discrete CPU(s), or dCPU(s)), that can be coupled to the SoC(s) 804 using a high-speed interconnect (e.g., PCIe). The CPU(s) 818 can include an X86 processor, for example. The CPU(s) 818 can be used to perform any of a variety of functions, including arbitrating potentially inconsistent results between ADAS sensors and the SoC(s) 804, and/or monitoring the status and health of the controller(s) 836 and/or infotainment SoC 830, for example.

The vehicle 800 can include a GPU(s) 820 (e.g., discrete GPU(s), or dGPU(s)), that can be coupled to the SoC(s) 804 using a high-speed interconnect (e.g., NVIDIA's NVLINK). The GPU(s) 820 can provide additional artificial intelligence functionality, such as by executing redundant and/or different neural networks, and can be used to train and/or update neural networks based at least on input (e.g., sensor data) from sensors of the vehicle 800.

The vehicle 800 can further include the network interface 824 which can include one or more wireless antennas 826 (e.g., one or more wireless antennas for different communication protocols, such as a cellular antenna, a Bluetooth antenna, etc.). The network interface 824 can be used to enable wireless connectivity over the Internet with the cloud (e.g., with the server(s) 878 and/or other network devices), with other vehicles, and/or with computing devices (e.g., client devices of passengers). To communicate with other vehicles, a direct link can be established between the two vehicles and/or an indirect link can be established (e.g., across networks and over the Internet). Direct links can be provided using a vehicle-to-vehicle communication link. The vehicle-to-vehicle communication link can provide the vehicle 800 information about vehicles in proximity to the vehicle 800 (e.g., vehicles in front of, on the side of, and/or behind the vehicle 800). This functionality can be part of a cooperative adaptive cruise control functionality of the vehicle 800.

The network interface 824 can include a SoC that provides modulation and demodulation functionality and enables the controller(s) 836 to communicate over wireless networks. The network interface 824 can include a radio frequency front-end for up-conversion from baseband to radio frequency, and down conversion from radio frequency to baseband. The frequency conversions can be performed through well-known processes, and/or can be performed using super-heterodyne processes. In some examples, the radio frequency front end functionality can be provided by a separate chip. The network interface can include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 800 can further include data store(s) 828 which can include off-chip (e.g., off the SoC(s) 804) storage. The data store(s) 828 can include one or more storage elements including RAM, SRAM, DRAM, VRAM, Flash, hard disks, and/or other components and/or devices that can store at least one bit of data.

The vehicle 800 can further include GNSS sensor(s) 858. The GNSS sensor(s) 858 (e.g., GPS, assisted GPS sensors, differential GPS (DGPS) sensors, etc.), to assist in mapping, perception, occupancy grid generation, and/or path planning functions. Any number of GNSS sensor(s) 858 can be used, including, for example and without limitation, a GPS using a USB connector with an Ethernet to Serial (RS-232) bridge.

The vehicle 800 can further include RADAR sensor(s) 860. The RADAR sensor(s) 860 can be used by the vehicle 800 for long-range vehicle detection, even in darkness and/or severe weather conditions. RADAR functional safety levels can be ASIL B. The RADAR sensor(s) 860 can use the CAN and/or the bus 802 (e.g., to transmit data generated by the RADAR sensor(s) 860) for control and to access object tracking data, with access to Ethernet to access raw data in some examples. A wide variety of RADAR sensor types can be used. For example, and without limitation, the RADAR sensor(s) 860 can be suitable for front, rear, and side RADAR use. In some example, Pulse Doppler RADAR sensor(s) are used.

The RADAR sensor(s) 860 can include different configurations, such as long range with narrow field of view, short range with wide field of view, short range side coverage, etc. In some examples, long-range RADAR can be used for adaptive cruise control functionality. The long-range RADAR systems can provide a broad field of view realized by two or more independent scans, such as within a 250 m range. The RADAR sensor(s) 860 can help in distinguishing between static and moving objects, and can be used by ADAS systems for emergency brake assist and forward collision warning. Long-range RADAR sensors can include monostatic multimodal RADAR with multiple (e.g., six or more) fixed RADAR antennae and a high-speed CAN and FlexRay interface. In an example with six antennae, the central four antennae can create a focused beam pattern, designed to record the vehicle's 800 surroundings at higher speeds with minimal interference from traffic in adjacent lanes. The other two antennae can expand the field of view, making it possible to quickly detect vehicles entering or leaving the vehicle's 800 lane.

Mid-range RADAR systems can include, as an example, a range of up to 760 m (front) or 80 m (rear), and a field of view of up to 42 degrees (front) or 750 degrees (rear). Short-range RADAR systems can include, without limitation, RADAR sensors designed to be installed at both ends of the rear bumper. When installed at both ends of the rear bumper, such a RADAR sensor systems can create two beams that constantly monitor the blind spot in the rear and next to the vehicle.

Short-range RADAR systems can be used in an ADAS system for blind spot detection and/or lane change assist.

The vehicle 800 can further include ultrasonic sensor(s) 862. The ultrasonic sensor(s) 862, which can be positioned at the front, back, and/or the sides of the vehicle 800, can be used for park assist and/or to create and update an occupancy grid. A wide variety of ultrasonic sensor(s) 862 can be used, and different ultrasonic sensor(s) 862 can be used for different ranges of detection (e.g., 2.5 m, 4 m). The ultrasonic sensor(s) 862 can operate at functional safety levels of ASIL B.

The vehicle 800 can include LIDAR sensor(s) 864. The LIDAR sensor(s) 864 can be used for object and pedestrian detection, emergency braking, collision avoidance, and/or other functions. The LIDAR sensor(s) 864 can be functional safety level ASIL B. In some examples, the vehicle 800 can include multiple LIDAR sensors 864 (e.g., two, four, six, etc.) that can use Ethernet (e.g., to provide data to a Gigabit Ethernet switch).

In some examples, the LIDAR sensor(s) 864 can be capable of providing a list of objects and their distances for a 360-degree field of view. Commercially available LIDAR sensor(s) 864 can have an advertised range of approximately 700 m, with an accuracy of 2 cm-3 cm, and with support for a 700 Mbps Ethernet connection, for example. In some examples, one or more non-protruding LIDAR sensors 864 can be used. In such examples, the LIDAR sensor(s) 864 can be implemented as a small device that can be embedded into the front, rear, sides, and/or corners of the vehicle 800. The LIDAR sensor(s) 864, in such examples, can provide up to a 120-degree horizontal and 35-degree vertical field-of-view, with a 200 m range even for low-reflectivity objects. Front-mounted LIDAR sensor(s) 864 can be configured for a horizontal field of view between 45 degrees and 135 degrees.

In some examples, LIDAR technologies, such as 3D flash LIDAR, can also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR can allow for highly accurate and distortion-free images of the surroundings to be generated with every laser flash. In some examples, four flash LIDAR sensors can be deployed, one at each side of the vehicle 800. Available 3D flash LIDAR systems include a solid-state 3D staring array LIDAR camera with no moving parts other than a fan (e.g., a non-scanning LIDAR device). The flash LIDAR device can use a 5 nanosecond class I (eye-safe) laser pulse per frame and can capture the reflected laser light in the form of 3D range point clouds and co-registered intensity data. By using flash LIDAR, and because flash LIDAR is a solid-state device with no moving parts, the LIDAR sensor(s) 864 can be less susceptible to motion blur, vibration, and/or shock.

The vehicle can further include IMU sensor(s) 866. The IMU sensor(s) 866 can be located at a center of the rear axle of the vehicle 800, in some examples. The IMU sensor(s) 866 can include, for example and without limitation, an accelerometer(s), a magnetometer(s), a gyroscope(s), a magnetic compass(es), and/or other sensor types. In some examples, such as in six-axis applications, the IMU sensor(s) 866 can include accelerometers and gyroscopes, while in nine-axis applications, the IMU sensor(s) 866 can include accelerometers, gyroscopes, and magnetometers.

In some embodiments, the IMU sensor(s) 866 can be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 866 can enable the vehicle 800 to estimate heading without requiring input from a magnetic sensor by directly observing and correlating the changes in velocity from GPS to the IMU sensor(s) 866. In some examples, the IMU sensor(s) 866 and the GNSS sensor(s) 858 can be combined in a single integrated unit.

The vehicle can include microphone(s) 896 placed in and/or around the vehicle 800. The microphone(s) 896 can be used for emergency vehicle detection and identification, among other things.

The vehicle can further include any number of camera types, including stereo camera(s) 868, wide-view camera(s) 870, infrared camera(s) 872, surround camera(s) 874, long-range and/or mid-range camera(s) 898, and/or other camera types. The cameras can be used to capture image data around an entire periphery of the vehicle 800. The types of cameras used depends on the embodiments and requirements for the vehicle 800, and any combination of camera types can be used to provide the necessary coverage around the vehicle 800. In addition, the number of cameras can differ depending on the embodiment. For example, the vehicle can include six cameras, seven cameras, ten cameras, twelve cameras, and/or another number of cameras. The cameras can support, as an example and without limitation, Gigabit Multimedia Serial Link (GMSL) and/or Gigabit Ethernet. Each of the camera(s) is described with more detail herein with respect to FIG. 8A and FIG. 8B.

The vehicle 800 can further include vibration sensor(s) 842. The vibration sensor(s) 842 can measure vibrations of components of the vehicle, such as the axle(s). For example, changes in vibrations can indicate a change in road surfaces. In another example, when two or more vibration sensors 842 are used, the differences between the vibrations can be used to determine friction or slippage of the road surface (e.g., when the difference in vibration is between a power-driven axle and a freely rotating axle).

The vehicle 800 can include an ADAS system 838. The ADAS system 838 can include a SoC, in some examples. The ADAS system 838 can include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems can use RADAR sensor(s) 860, LIDAR sensor(s) 864, and/or a camera(s). The ACC systems can include longitudinal ACC and/or lateral ACC. Longitudinal ACC monitors and controls the distance to the vehicle immediately ahead of the vehicle 800 and automatically adjust the vehicle speed to maintain a safe distance from vehicles ahead. Lateral ACC performs distance keeping, and advises the vehicle 800 to change lanes when necessary. Lateral ACC is related to other ADAS applications such as LCA and CWS.

CACC uses information from other vehicles that can be obtained using the network interface 824 and/or the wireless antenna(s) 826 from other vehicles using a wireless link, or indirectly, over a network connection (e.g., over the Internet). Direct links can be provided by a vehicle-to-vehicle (V2V) communication link, while indirect links can be infrastructure-to-vehicle (I2V) communication link. In general, the V2V communication concept provides information about the immediately preceding vehicles (e.g., vehicles immediately ahead of and in the same lane as the vehicle 800), while the I2V communication concept provides information about traffic further ahead. CACC systems can include either or both I2V and V2V information sources. Given the information of the vehicles ahead of the vehicle 800, CACC can be more reliable and it has potential to improve traffic flow smoothness and reduce congestion on the road.

FCW systems are designed to alert the driver to a hazard, so that the driver can take corrective action. FCW systems use a front-facing camera and/or RADAR sensor(s) 860, coupled to a dedicated processor, DSP, FPGA, and/or ASIC, that is electrically coupled to driver feedback, such as a display, speaker, and/or vibrating component. FCW systems can provide a warning, such as in the form of a sound, visual warning, vibration and/or a quick brake pulse.

AEB systems detect an impending forward collision with another vehicle or other object, and can automatically apply the brakes if the driver does not take corrective action within a specified time or distance parameter. AEB systems can use front-facing camera(s) and/or RADAR sensor(s) 860, coupled to a dedicated processor, DSP, FPGA, and/or ASIC. When the AEB system detects a hazard, it typically first alerts the driver to take corrective action to avoid the collision and, if the driver does not take corrective action, the AEB system can automatically apply the brakes in an effort to prevent, or at least mitigate, the impact of the predicted collision. AEB systems, can include techniques such as dynamic brake support and/or crash imminent braking.

LDW systems provide visual, audible, and/or tactile warnings, such as steering wheel or seat vibrations, to alert the driver when the vehicle 800 crosses lane markings. A LDW system does not activate when the driver indicates an intentional lane departure, by activating a turn signal. LDW systems can use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 800 if the vehicle 800 starts to exit the lane.

BSW systems detects and warn the driver of vehicles in an automobile's blind spot. BSW systems can provide a visual, audible, and/or tactile alert to indicate that merging or changing lanes is unsafe. The system can provide an additional warning when the driver uses a turn signal. BSW systems can use rear-side facing camera(s) and/or RADAR sensor(s) 860, coupled to a dedicated processor, DSP, FPGA, and/or ASIC, that is electrically coupled to driver feedback, such as a display, speaker, and/or vibrating component.

RCTW systems can provide visual, audible, and/or tactile notification when an object is detected outside the rear-camera range when the vehicle 800 is backing up. Some RCTW systems include AEB to ensure that the vehicle brakes are applied to avoid a crash. RCTW systems can use one or more rear-facing RADAR sensor(s) 860, coupled to a dedicated processor, DSP, FPGA, and/or ASIC, that is electrically coupled to driver feedback, such as a display, speaker, and/or vibrating component.

Conventional ADAS systems can be prone to false positive results which can be annoying and distracting to a driver, but typically are not catastrophic, because the ADAS systems alert the driver and allow the driver to decide whether a safety condition truly exists and act accordingly. However, in an autonomous vehicle 800, the vehicle 800 itself must, in the case of conflicting results, decide whether to heed the result from a primary computer or a secondary computer (e.g., a first controller 836 or a second controller 836). For example, in some embodiments, the ADAS system 838 can be a backup and/or secondary computer for providing perception information to a backup computer rationality module. The backup computer rationality monitor can run a redundant diverse software on hardware components to detect faults in perception and dynamic driving tasks. Outputs from the ADAS system 838 can be provided to a supervisory MCU. If outputs from the primary computer and the secondary computer conflict, the supervisory MCU must determine how to reconcile the conflict to ensure safe operation.

In some examples, the primary computer can be configured to provide the supervisory MCU with a confidence score, indicating the primary computer's confidence in the chosen result. If the confidence score exceeds a threshold, the supervisory MCU can follow the primary computer's direction, regardless of whether the secondary computer provides a conflicting or inconsistent result. Where the confidence score does not meet the threshold, and where the primary and secondary computer indicate different results (e.g., the conflict), the supervisory MCU can arbitrate between the computers to determine the appropriate outcome.

The supervisory MCU can be configured to run a neural network(s) that is trained/updated and configured to determine, based at least on outputs from the primary computer and the secondary computer, conditions under which the secondary computer provides false alarms. Thus, the neural network(s) in the supervisory MCU can learn when the secondary computer's output can be trusted, and when it cannot. For example, when the secondary computer is a RADAR-based FCW system, a neural network(s) in the supervisory MCU can learn when the FCW system is identifying metallic objects that are not, in fact, hazards, such as a drainage grate or manhole cover that triggers an alarm. Similarly, when the secondary computer is a camera-based LDW system, a neural network in the supervisory MCU can learn to override the LDW when bicyclists or pedestrians are present and a lane departure is, in fact, the safest maneuver. In embodiments that include a neural network(s) running on the supervisory MCU, the supervisory MCU can include at least one of a DLA or GPU suitable for running the neural network(s) with associated memory. In preferred embodiments, the supervisory MCU can comprise and/or be included as a component of the SoC(s) 804.

In other examples, ADAS system 838 can include a secondary computer that performs ADAS functionality using traditional rules of computer vision. As such, the secondary computer can use classic computer vision rules (if-then), and the presence of a neural network(s) in the supervisory MCU can improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU can have greater confidence that the overall result is correct, and the bug in software or hardware on primary computer is not causing material error.

In some examples, the output of the ADAS system 838 can be fed into the primary computer's perception block and/or the primary computer's dynamic driving task block. For example, if the ADAS system 838 indicates a forward crash warning due to an object immediately ahead, the perception block can use this information when identifying objects. In other examples, the secondary computer can have its own neural network which is trained/updated and thus reduces the risk of false positives, as described herein.

The vehicle 800 can further include the infotainment SoC 830 (e.g., an in-vehicle infotainment system (IVI)). Although illustrated and described as a SoC, the infotainment system can not be a SoC, and can include two or more discrete components. The infotainment SoC 830 can include a combination of hardware and software that can be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 800. For example, the infotainment SoC 830 can radios, disk players, navigation systems, video players, USB and Bluetooth connectivity, carputers, in-car entertainment, Wi-Fi, steering wheel audio controls, hands free voice control, a heads-up display (HUD), an HMI display 834, a telematics device, a control panel (e.g., for controlling and/or interacting with various components, features, and/or systems), and/or other components. The infotainment SoC 830 can further be used to provide information (e.g., visual and/or audible) to a user(s) of the vehicle, such as information from the ADAS system 838, autonomous driving information such as planned vehicle maneuvers, trajectories, surrounding environment information (e.g., intersection information, vehicle information, road information, etc.), and/or other information.

The infotainment SoC 830 can include GPU functionality. The infotainment SoC 830 can communicate over the bus 802 (e.g., CAN bus, Ethernet, etc.) with other devices, systems, and/or components of the vehicle 800. In some examples, the infotainment SoC 830 can be coupled to a supervisory MCU such that the GPU of the infotainment system can perform some self-driving functions in the event that the primary controller(s) 836 (e.g., the primary and/or backup computers of the vehicle 800) fail. In such an example, the infotainment SoC 830 can put the vehicle 800 into a chauffeur to safe stop mode, as described herein.

The vehicle 800 can further include an instrument cluster 832 (e.g., a digital dash, an electronic instrument cluster, a digital instrument panel, etc.). The instrument cluster 832 can include a controller and/or supercomputer (e.g., a discrete controller or supercomputer). The instrument cluster 832 can include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information can be displayed and/or shared among the infotainment SoC 830 and the instrument cluster 832. In other words, the instrument cluster 832 can be included as part of the infotainment SoC 830, or vice versa.

FIG. 8D is a system diagram for communication between cloud-based server(s) and the example autonomous vehicle 800 of FIG. 8A, in accordance with some embodiments of the present disclosure. The system 876 can include server(s) 878, network(s) 890, and vehicles, including the vehicle 800. The server(s) 878 can include a plurality of GPUs 884(A)-884(H) (collectively referred to herein as GPUs 884), PCIe switches 882(A)-882(H) (collectively referred to herein as PCIe switches 882), and/or CPUs 880(A)-880(B) (collectively referred to herein as CPUs 880). The GPUs 884, the CPUs 880, and the PCIe switches can be interconnected with high-speed interconnects such as, for example and without limitation, NVLink interfaces 888 developed by NVIDIA and/or PCIe connections 886. In some examples, the GPUs 884 are connected using NVLink and/or NVSwitch SoC and the GPUs 884 and the PCIe switches 882 are connected using PCIe interconnects. Although eight GPUs 884, two CPUs 880, and two PCIe switches are illustrated, this is not intended to be limiting. Depending on the embodiment, each of the server(s) 878 can include any number of GPUs 884, CPUs 880, and/or PCIe switches. For example, the server(s) 878 can each include eight, sixteen, thirty-two, and/or more GPUs 884.

The server(s) 878 can obtain, over the network(s) 890 and from the vehicles, image data representative of images showing unexpected or changed road conditions, such as recently commenced road-work. The server(s) 878 can transmit, over the network(s) 890 and to the vehicles, neural networks 892, updated neural networks 892, and/or map information 894, including information regarding traffic and road conditions. The updates to the map information 894 can include updates for the HD map 822, such as information regarding construction sites, potholes, detours, flooding, and/or other obstructions. In some examples, the neural networks 892, the updated neural networks 892, and/or the map information 894 can have resulted from new training/updating and/or experiences represented in data obtained from any number of vehicles in the environment, and/or based at least on training/updating performed at a datacenter (e.g., using the server(s) 878 and/or other servers).

The server(s) 878 can be used to train/update machine learning models (e.g., neural networks) based at least on training data. The training data can be generated by the vehicles, and/or can be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training/updating can be executed according to any one or more classes of machine learning techniques, including, without limitation, classes such as: supervised training/updating, semi-supervised training/updating, unsupervised training/updating, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained/updated, the machine learning models can be used by the vehicles (e.g., transmitted to the vehicles over the network(s) 890, and/or the machine learning models can be used by the server(s) 878 to remotely monitor the vehicles.

In some examples, the server(s) 878 can obtain data from the vehicles and apply the data to up-to-date real-time neural networks for real-time intelligent inferencing. The server(s) 878 can include deep-learning supercomputers and/or dedicated AI computers powered by GPU(s) 884, such as a DGX and DGX Station machines developed by NVIDIA. However, in some examples, the server(s) 878 can include deep learning infrastructure that use only CPU-powered datacenters.

The deep-learning infrastructure of the server(s) 878 can be capable of fast, real-time inferencing, and can use that capability to evaluate and verify the health of the processors, software, and/or associated hardware in the vehicle 800. For example, the deep-learning infrastructure can obtain periodic updates from the vehicle 800, such as a sequence of images and/or objects that the vehicle 800 has located in that sequence of images (e.g., using computer vision and/or other machine learning object classification techniques). The deep-learning infrastructure can run its own neural network to identify the objects and compare them with the objects identified by the vehicle 800 and, if the results do not match and the infrastructure concludes that the AI in the vehicle 800 is malfunctioning, the server(s) 878 can transmit a signal to the vehicle 800 instructing a fail-safe computer of the vehicle 800 to assume control, notify the passengers, and complete a safe parking maneuver.

For inferencing, the server(s) 878 can include the GPU(s) 884 and one or more programmable inference accelerators (e.g., NVIDIA's TensorRT). The combination of GPU-powered servers and inference acceleration can make real-time responsiveness possible. In other examples, such as where performance is less critical, servers powered by CPUs, FPGAs, and other processors can be used for inferencing.

### Example Computing Device

FIG. 9 is a block diagram of an example computing device(s) 900 (e.g., vehicle processor 110) suitable for use in implementing some embodiments of the present disclosure. Computing device 900 can include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 can comprise one or more virtual machines (VMs), and/or any of the components thereof can comprise virtual components (e.g., virtual hardware components). For non-limiting examples, one or more of the GPUs 908 can comprise one or more vGPUs, one or more of the CPUs 906 can comprise one or more vCPUs, and/or one or more of the logic units 920 can comprise one or more virtual logic units. As such, a computing device(s) 900 can include discrete components (e.g., a full GPU dedicated to the computing device 900), virtual components (e.g., a portion of a GPU dedicated to the computing device 900), or a combination thereof.

Although the various blocks of FIG. 9 are shown as connected using the interconnect system 902 with lines, this is not intended to be limiting and is for clarity only. For example, in some embodiments, a presentation component 918, such as a display device, can be considered an I/O component 914 (e.g., if the display is a touch screen). As another example, the CPUs 906 and/or GPUs 908 can include memory (e.g., the memory 904 can be representative of a storage device in addition to the memory of the GPUs 908, the CPUs 906, and/or other components). In other words, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 can represent one or more links or busses, such as an address bus, a data bus, a control bus, or a combination thereof. The interconnect system 902 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 can be directly connected to the memory 904. Further, the CPU 906 can be directly connected to the GPU 908. Where there is direct, or point-to-point connection between components, the interconnect system 902 can include a PCIe link to carry out the connection. In these examples, a PCI bus need not be included in the computing device 900.

The memory 904 can include any of a variety of computer-readable media. The computer-readable media can be any available media that can be accessed by the computing device 900. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 904 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 906 can be configured to execute at least some of the computer-readable instructions to control one or more components of the computing device 900 to perform one or more of the methods and/or processes described herein. The CPU(s) 906 can each include one or more cores (e.g., one, two, four, eight, twenty-eight, seventy-two, etc.) that are capable of handling a multitude of software threads simultaneously. The CPU(s) 906 can include any type of processor, and can include different types of processors depending on the type of computing device 900 implemented (e.g., processors with fewer cores for mobile devices and processors with more cores for servers). For example, depending on the type of computing device 900, the processor can be an Advanced RISC Machines (ARM) processor implemented using Reduced Instruction Set Computing (RISC) or an x86 processor implemented using Complex Instruction Set Computing (CISC). The computing device 900 can include one or more CPUs 906 in addition to one or more microprocessors or supplementary co-processors, such as math co-processors.

In addition to or alternatively from the CPU(s) 906, the GPU(s) 908 can be configured to execute at least some of the computer-readable instructions to control one or more components of the computing device 900 to perform one or more of the methods and/or processes described herein. One or more of the GPU(s) 908 can be an integrated GPU (e.g., with one or more of the CPU(s) 906 and/or one or more of the GPU(s) 908 can be a discrete GPU. In embodiments, one or more of the GPU(s) 908 can be a coprocessor of one or more of the CPU(s) 906. The GPU(s) 908 can be used by the computing device 900 to render graphics (e.g., 3D graphics) or perform general purpose computations. For example, the GPU(s) 908 can be used for General-Purpose computing on GPUs (GPGPU). The GPU(s) 908 can include hundreds or thousands of cores that are capable of handling hundreds or thousands of software threads simultaneously. The GPU(s) 908 can generate pixel data for output images in response to rendering commands (e.g., rendering commands from the CPU(s) 906 obtained using a host interface). The GPU(s) 908 can include graphics memory, such as display memory, for storing pixel data or any other suitable data, such as GPGPU data. The display memory can be included as part of the memory 904. The GPU(s) 908 can include two or more GPUs operating in parallel (e.g., using a link). The link can directly connect the GPUs (e.g., using NVLINK) or can connect the GPUs through a switch (e.g., using NVSwitch). When combined together, each GPU 908 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 906 and/or the GPU(s) 908, the logic unit(s) 920 can be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 can discretely or jointly perform any combination of the methods, processes and/or portions thereof. One or more of the logic units 920 can be part of and/or integrated in one or more of the CPU(s) 906 and/or the GPU(s) 908 and/or one or more of the logic units 920 can be discrete components or otherwise external to the CPU(s) 906 and/or the GPU(s) 908. In embodiments, one or more of the logic units 920 can be a coprocessor of one or more of the CPU(s) 906 and/or one or more of the GPU(s) 908.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, etc.

The communication interface 910 can include one or more receivers, transmitters, and/or transceivers that enable the computing device 900 to communicate with other computing devices using an electronic communication network, included wired and/or wireless communications. The communication interface 910 can include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 can include one or more data processing units (DPUs) to transmit data obtained over a network and/or through interconnect system 902 directly to (e.g., a memory of) one or more GPU(s) 908.

The I/O ports 912 can enable the computing device 900 to be logically coupled to other devices including the I/O components 914, the presentation component(s) 918, and/or other components, some of which can be built in to (e.g., integrated in) the computing device 900. Illustrative I/O components 914 include a microphone, mouse, keyboard, joystick, game pad, game controller, satellite dish, scanner, printer, wireless device, etc. The I/O components 914 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 can be include depth cameras, such as stereoscopic camera systems, infrared camera systems, RGB camera systems, touchscreen technology, and combinations of these, for gesture detection and recognition. Additionally, the computing device 900 can include accelerometers or gyroscopes (e.g., as part of an inertia measurement unit (IMU)) that enable detection of motion. In some examples, the output of the accelerometers or gyroscopes can be used by the computing device 900 to render immersive augmented reality or virtual reality.

The power supply 916 can include a hard-wired power supply, a battery power supply, or a combination thereof. The power supply 916 can provide power to the computing device 900 to enable the components of the computing device 900 to operate.

The presentation component(s) 918 can include a display (e.g., a monitor, a touch screen, a television screen, a heads-up-display (HUD), other display types, or a combination thereof), speakers, and/or other presentation components. The presentation component(s) 918 can obtain data from other components (e.g., the GPU(s) 908, the CPU(s) 906, DPUs, etc.), and output the data (e.g., as an image, video, sound, etc.).

### Example Data Center

FIG. 10 illustrates an example data center 1000 that can be used in at least one embodiments of the present disclosure. The data center 1000 can include a data center infrastructure layer 1010, a framework layer 1020, a software layer 1030, and/or an application layer 1040.

As shown in FIG. 10, the data center infrastructure layer 1010 can include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) can correspond to a server having one or more of the above-mentioned computing resources. In addition, in other embodiments, the node C.R.s 1016(1)-1016(N) can include one or more virtual components, such as vGPUs, vCPUs, etc., and/or one or more of the node C.R.s 1016(1)-1016(N) can correspond to a virtual machine (VM).

In at least one embodiment, grouped computing resources 1014 can include separate groupings of node C.R.s 1016 housed within one or more racks (not shown), or many racks housed in data centers at various geographical locations (also not shown). Separate groupings of node C.R.s 1016 within grouped computing resources 1014 can include grouped compute, network, memory or storage resources that can be configured or allocated to support one or more workloads. In at least one embodiment, several node C.R.s 1016 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 1012 can configure or otherwise control one or more node C.R.s 1016(1)-1016(N) and/or grouped computing resources 1014. In at least one embodiment, resource orchestrator 1012 can include a software design infrastructure (SDI) management entity for the data center 1000. The resource orchestrator 1012 can include hardware, software, or some combination thereof.

In at least one embodiment, as shown in FIG. 10, framework layer 1020 can include a job scheduler 1033, a configuration manager 1034, a resource manager 1036, and/or a distributed file system 1038. The framework layer 1020 can include a framework to support software 1032 of software layer 1030 and/or one or more application(s) 1042 of application layer 1040. The software 1032 or application(s) 1042 can respectively include web-based service software or applications, such as those provided by Amazon Web Services, Google Cloud and Microsoft Azure. The framework layer 1020 can be, but is not limited to, a type of free and open-source software web application framework such as Apache Spark™ (hereinafter “Spark”) that can utilize distributed file system 1038 for large-scale data processing (e.g., “big data”). In at least one embodiment, job scheduler 1033 can include a Spark driver to facilitate scheduling of workloads supported by various layers of data center 1000. The configuration manager 1034 can be capable of configuring different layers such as software layer 1030 and framework layer 1020 including Spark and distributed file system 1038 for supporting large-scale data processing. The resource manager 1036 can be capable of managing clustered or grouped computing resources mapped to or allocated for support of distributed file system 1038 and job scheduler 1033. In at least one embodiment, clustered or grouped computing resources can include grouped computing resource 1014 at data center infrastructure layer 1010. The resource manager 1036 can coordinate with resource orchestrator 1012 to manage these mapped or allocated computing resources.

In at least one embodiment, software 1032 included in software layer 1030 can include software used by at least portions of node C.R.s 1016(1)-1016(N), grouped computing resources 1014, and/or distributed file system 1038 of framework layer 1020. One or more types of software can include, but are not limited to, Internet web page search software, e-mail virus scan software, database software, and streaming video content software.

In at least one embodiment, application(s) 1042 included in application layer 1040 can include one or more types of applications used by at least portions of node C.R.s 1016(1)-1016(N), grouped computing resources 1014, and/or distributed file system 1038 of framework layer 1020. One or more types of applications can include, but are not limited to, any number of a genomics application, a cognitive compute, and a machine learning application, including training/updating or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 can implement any number and type of self-modifying actions based at least on any amount and type of data acquired in any technically feasible fashion. Self-modifying actions can relieve a data center operator of data center 1000 from making possibly bad configuration decisions and possibly avoiding underutilized and/or poor performing portions of a data center.

The data center 1000 can include tools, services, software or other resources to train/update one or more machine learning models or predict or infer information using one or more machine learning models according to one or more embodiments described herein. For example, a machine learning model(s) can be trained/updated by calculating weight parameters according to a neural network architecture using software and/or computing resources described above with respect to the data center 1000. In at least one embodiment, trained/updated or deployed machine learning models corresponding to one or more neural networks can be used to infer or predict information using resources described above with respect to the data center 1000 by using weight parameters calculated through one or more training/updating techniques, such as but not limited to those described herein.

In at least one embodiment, the data center 1000 can use CPUs, application-specific integrated circuits (ASICs), GPUs, FPGAs, and/or other hardware (or virtual compute resources corresponding thereto) to perform training/updating and/or inferencing using above-described resources. Moreover, one or more software and/or hardware resources described above can be configured as a service to allow users to train/update or performing inferencing of information, such as image recognition, speech recognition, or other artificial intelligence services.

### Example Network Environments

Network environments suitable for use in implementing embodiments of the disclosure can include one or more client devices, servers, network attached storage (NAS), other backend devices, and/or other device types. The client devices, servers, and/or other device types (e.g., each device) can be implemented on one or more instances of the computing device(s) 900 of FIG. 9—e.g., each device can include similar components, features, and/or functionality of the computing device(s) 900. In addition, where backend devices (e.g., servers, NAS, etc.) are implemented, the backend devices can be included as part of a data center 1000, an example of which is described in more detail herein with respect to FIG. 10.

Components of a network environment can communicate with each other using a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server can not be included in a network environment—and one or more client-server network environments—in which case one or more servers can be included in a network environment. In peer-to-peer network environments, functionality described herein with respect to a server(s) can be implemented on any number of client devices.

In at least one embodiment, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In embodiments, one or more of the client devices can use the web-based service software or applications (e.g., by accessing the service software and/or applications using one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 900 described herein with respect to FIG. 9. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
obtain scene data associated with movement of one or more agents relative to a machine navigating through an environment;
encode the scene data to determine one or more latent representations of the movement of the one or more agents relative to the machine navigating through the environment;
determine a joint scene mode distribution based at least on the one or more latent representations; and
decode the joint scene mode distribution into one or more trajectory predictions and one or more categorical predictions for at least one agent of the one or more agents.

2. The one or more processors of claim 1, wherein to obtain the scene data, the one or more circuits are to:
obtain the scene data based at least on execution of a perception system,
wherein the perception system is configured to generate the scene data based at least on sensor data generated by one or more sensors of the machine representing positions of the one or more agents relative to the machine.

3. The one or more processors of claim 1, wherein, to encode the scene data, the one or more circuits are to:
determine one or more latent representations comprising first pairwise relationships between pairs of agents of the one or more agents and second pairwise relationships between at least one agent of the one or more agents and a lane segment of a plurality of lane segments of the environment.

4. The one or more processors of claim 3, wherein the one or more circuits are to:
determine a lane mode distribution and a homotopy distribution based at least on the first pairwise relationships and the second pairwise relationships; and
determine the joint scene mode distribution based at least on the lane mode distribution and the homotopy distribution.

5. The one or more processors of claim 4, wherein, to determine the lane mode distribution and the homotopy distribution, the one or more circuits are to:
execute a graph neural network (GNN) comprising a plurality of node embeddings and a plurality of edge embeddings based at least on the first pairwise relationships and the second pairwise relationships,
where the plurality of node embeddings comprises a first subset of node embeddings associated with one or more lane segments of the environment, a second subset of node embeddings associated with the movement of one or more agents during a first period of time, and a third subset of node embeddings associated with future predicted movement of the one or more agents during a second period of time, and
where the plurality of edge embeddings comprise a first subset of edge embeddings associated with first relationships between the one or more agents and corresponding lane segments of the environment, and a second subset of edge embeddings associated with second relationships between the one or more agents.

6. The one or more processors of claim 5, wherein, to execute the GNN, the one or more circuits are to:
for at least one message passing phase of a plurality of message passing phases:
perform an edge update by concatenating at least one edge embedding with at least two node embeddings corresponding to the at least one edge embedding; and
perform a node update by concatenating each of the at least two node embeddings with one or more edge embeddings of the plurality of edge embeddings.

7. The one or more processors of claim 6, wherein the one or more circuits are to:
in response to performing the edge update:
perform one or more self-attention operations for each of the first subset of node embeddings, the second subset of node embeddings, and the third subset of node embeddings, and
perform one or more cross-attention operations between the first subset of nodes and the second subset of nodes, and
perform one or more cross-attention operations between the first subset of nodes and the third subset of nodes.

8. The one or more processors of claim 7, wherein, to execute the GNN, the one or more circuits are to:
in response to performing a final edge update and a final node update, determining the joint scene mode distribution based at least on the plurality of node embeddings and the plurality of edge embeddings.

9. The one or more processors of claim 1, wherein the one or more circuits are to:
generate a prompt based at least on the one or more trajectory predictions and the one or more categorical predictions, the prompt representing the one or more trajectory predictions and the one or more categorical predictions as related to the machine navigating through the environment.

10. The one or more processors of claim 1, wherein the one or more processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system for performing generative AI operations;
a system for implementing vision language models (VLMs);
a system for implementing large language models (LLMs);
a system for implementing multi-modal language models;
a system implemented using one or more cloud-hosted microservices;
a system for hosting one or more real-time streaming applications;
a system for performing light transport simulation;
a system for performing collaborative content creation for 3D assets; or
a system implemented at least partially using cloud computing resources.

11. A method, comprising:
obtaining scene data associated with movement of one or more agents relative to a machine navigating through an environment;
encoding the scene data to determine one or more latent representations of the movement of the one or more agents relative to the machine navigating through the environment;
determining a joint scene mode distribution based at least on the latent representations; and
decoding the joint scene mode distribution into one or more trajectory predictions and one or more categorical predictions for at least one agent of the one or more agents.

12. The method of claim 11, wherein obtaining the scene data comprises:
obtaining the scene data based at least on execution of a perception system, and
wherein the perception system is configured to generate the scene data based at least on sensor data generated by one or more sensors of the machine representing positions of the one or more agents relative to the machine.

13. The method of claim 11, wherein encoding the scene data comprises:
determining one or more latent representations comprising first pairwise relationships between pairs of agents of the one or more agents and second pairwise relationships between at least one agent of the one or more agents and a lane segment of a plurality of lane segments of the environment.

14. The method of claim 13, further comprising:
determining a lane mode distribution and a homotopy distribution based at least on the first pairwise relationships and the second pairwise relationships; and
determining a joint scene mode distribution based at least on the lane mode distribution and the homotopy distribution.

15. The method of claim 14, wherein determining the lane mode distribution and the homotopy distribution comprises:
executing a graph neural network (GNN) comprising a plurality of node embeddings and a plurality of edge embeddings based at least on the first pairwise relationships and the second pairwise relationships,
wherein the plurality of node embeddings comprises a first subset of node embeddings associated with lane segments of the environment, a second subset of node embeddings associated with the movement of one or more agents during a first period of time, and a third subset of node embeddings associated with future movement of the one or more agents during a second period of time, and
wherein the plurality of edge embeddings comprise a first subset of edge embeddings associated with first relationships between the one or more agents and corresponding lane segments of the environment, and a second subset of edge embeddings associated with second relationships between the one or more agents.

16. The method of claim 15, wherein executing the GNN further comprises:
for at least one message passing phase of a plurality of message passing phases:
performing an edge update by concatenating at least one edge embedding with at least two node embeddings corresponding to the at least one edge embedding; and
performing a node update by concatenating at least one node embedding with one or more edge embeddings of the plurality of edge embeddings.

17. The method of claim 16, further comprising:
in response to performing the edge update:
performing one or more self-attention operations for each of the first subset of node embeddings, the second subset of node embeddings, and the third subset of node embeddings, and
performing one or more cross-attention operations between the first subset of nodes and the second subset of nodes, and
performing one or more cross-attention operations between the first subset of nodes and the third subset of nodes.

18. The method of claim 17, wherein executing the GNN further comprises:
in response to performing a final edge update and a final node update, determining the joint scene mode distribution based at least on the plurality of node embeddings and the plurality of edge embeddings.

19. A system, comprising:
one or more processors to perform operations comprising:
obtaining scene data associated with movement of one or more agents relative to a machine navigating through an environment;
encoding the scene data to determine one or more latent representations of the movement of the one or more agents relative to the machine navigating through the environment;
determining a joint scene mode distribution based at least on the one or more latent representations; and
decoding the joint scene mode distribution into one or more trajectory predictions and one or more categorical predictions for at least one agent of the one or more agents.

20. The system of claim 19, wherein the system is comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system for performing generative AI operations;
a system for implementing vision language models (VLMs);
a system for implementing large language models (LLMs);
a system for implementing multi-modal language models;
a system implemented using one or more cloud-hosted microservices;
a system for hosting one or more real-time streaming applications;
a system for performing light transport simulation;
a system for performing collaborative content creation for 3D assets; or
a system implemented at least partially using cloud computing resources.
